(19) United States
(12) Patent Application Publication
(10) Pub. No.: US 2015/0189276 A1
(43) Pub. Date: Jul. 2, 2015

(54) VIDEO ENCODING METHOD AND APPARATUS, VIDEO DECODING METHOD AND APPARATUS, AND PROGRAMS THEREFOR

(71) Applicant: NIPPON TELEGRAPH AND TELEPHONE CORPORATION, Tokyo (JP)

(72) Inventors: Shiori Sugimoto, Yokosuka-shi (JP); Shinya Shimizu, Yokosuka-shi (JP); Hideaki Kimata, Yokosuka-shi (JP); Akira Kojima, Yokosuka-shi (JP)

(21) Appl. No.: 14/405,643

(22) PCT Filed: Jul. 9, 2013
(86) PCT No.: PCT/JP2013/068725

§ 371 Date: Dec. 4, 2014

(30) Foreign Application Priority Data
Jul. 9, 2012 (JP) 2012-153953

(51) Int. Cl. H04N 19/117; H04N 19/597; H04N 19/139; H04N 19/136; H04N 19/172

(52) U.S. Cl. CPC H04N 19/117; H04N 19/136; H04N 19/172; H04N 19/139; H04N 19/597

(57) ABSTRACT

When dividing each frame that forms an encoding target video into a plurality of processing regions and subjecting each processing region to predictive encoding, the encoding is executed by subjecting a prediction residual signal to downsampling that utilizes an interpolation filter. The interpolation filter whose filter coefficients are not encoded is determined by adaptively generating or selecting, for each processing region, the interpolation filter with reference to information that is able to be referred to when corresponding decoding is performed. A low-resolution prediction residual is obtained by subjecting the prediction residual signal to downsampling that utilizes the interpolation filter.

### CROSS-REFERENCE TO RELATED APPLICATIONS

This application is a 371 U.S. National Stage of International Application No. PCT/JP2013/068725, filed on Jul. 9, 2013, which claims priority to Japanese Patent Application No. 2012-153953, filed on Jul. 9, 2012. The entire disclosures of both of the above applications are incorporated herein by reference.

### TECHNICAL FIELD

The present invention relates to a video encoding method, a video decoding method, a video encoding apparatus, a video decoding apparatus, a video encoding program, and a video decoding program.

A method called “RRU (Reduced Resolution Update)” further improves the encoding efficiency by decreasing the resolution of at least part of the prediction residual before transformation and quantization of the prediction residual (see, for example, Non-Patent Document 1). Since the prediction is performed on a high-resolution basis and the prediction residual having a low resolution is subjected to an upsampling process during decoding thereof, a final image has a high resolution.

Although objective (image) quality is degraded according to such a process, the bit rate is eventually improved due to an increase in the number of encoding target bits. In addition, influence on subjective (image) quality is not strong in comparison with the influence on the objective quality.

The above-described function is supported by a standard called “ITU-T H.263”, and it is known that this function is particularly effective when a heavily dynamic region is present in a target sequence. This is because an RRU mode makes it possible to secure a high frame rate of the encoder and a preferable resolution and quality of such a dynamic region.

The above-described function is supported by a standard called “ITU-T H.263”, and it is known that this function is particularly effective when a heavily dynamic region is present in a target sequence. This is because an RRU mode makes it possible to secure a high frame rate of the encoder and a preferable resolution and quality of such a dynamic region.

However, the quality of the dynamic region is considerably affected by an accuracy for the upsampling of the prediction residual. Therefore, it is preferable and effective to have a method and an apparatus for RRU video encoding and decoding, which solve the above-described problems for the conventional technique.

Below, free viewpoint video encoding will be explained. In the free viewpoint video encoding, a target scene is imaged from a plurality of positions and at a plurality of angles by means of multiple imaging devices so as to obtain ray information about the scene. The ray information is utilized to reproduce ray information pertaining to any viewpoint, and thereby video (images) observed from said any viewpoint are generated.

Such ray information for a scene is represented in one of various data forms. One of most popular forms utilizes video and a depth image called a “depth map” for each of frames that form the video (see, for example, Non-Patent Document 2).

In the depth map, distance (i.e., depth) from the relevant camera to each object is described for each pixel, which implements simple representation of three-dimensional information about the object. When observing a single object from two cameras, each depth value of the object is proportional to the reciprocal of disparity between the cameras. Therefore, the depth map may be called a “disparity map (or disparity image)”.

Since one value is assigned to each pixel in the depth map representation, the depth map can be regarded as a gray scale image. In addition, similar to a video signal, depth map video images (below, “depth map” is applied to either of a simple image and a video image), which are temporally continued depth maps, have spatial and temporal correlation due to the spatial and temporal continuity of each object. Therefore, a video encoding method utilized to encode an ordinary video signal can efficiently encode a depth map by removing spatial and temporal redundancy.

Generally, video and the depth map have strong correlation with each other. Therefore, in order to encode both the video and depth map (as performed in the free viewpoint video encoding), the encoding efficiency can be further improved utilizing such correlation between the video and depth map.

Non-Patent Document 3 discloses a method of removing redundancy by commonly utilizing prediction information (about block division, motion vectors, and reference frames) for encoding both the video and depth map, and thereby efficient encoding is implemented.

### PRIOR ART DOCUMENT

Non-Patent Document
Non-Patent Document 1: A.M. Tourapis, J. Boyce, “Reduced Resolution Update Mode for Advanced Video Coding”, ITU-T Q6/SG16, document VCEG-V05, Munich, March 2004.
Non-Patent Document 2: Y. Mori, N. Fukusima, T. Fuji, and M. Tanimoto, “View Generation with 3D Warping Using Depth Information for FTV”, In Proceedings of 3DTV-CON2008, pp. 229-232, May 2008.
Non-Patent Document 3: I. Daribo, C. Tillier, and B. P. Popescu, “Motion Vector Sharing and Bitrate Allocation for 3D Video-Plus-Depth Coding,” EURASIP Journal on Advances in Signal Processing, vol. 2009, Article ID 258920, 13 pages, 2009.

### DISCLOSURE OF INVENTION

### Problem to be Solved by the Invention

Conventional RRU processes the prediction residual of each block without using data from any part outside the relevant block. Each prediction residual having a low resolution is computed from a high-resolution prediction residual utilizing downsampling interpolation (e.g., two-dimensional bilinear interpolation) based on relative positions of relevant samples. In order to obtain a decoded block, the relevant low-resolution prediction residual is encoded, reconstructed, and subjected to upsampling interpolation so that the residual is restored as a high-resolution prediction residual, which is added to a predicted image.

FIGS. 19 and 20 are diagrams that each show a spatial arrangement between high-resolution predicted residual samples and low-resolution prediction residual samples in conventional RRU and an example computation for the upsampling interpolation.

In each of the figures, white circles show the arrangement of the high-resolution prediction residual samples, and shaded circles the arrangement of the low-resolution prediction residual samples. Additionally, characters “a” to “e” and “A” to “D” in some circles shows examples of the pixel value. Specifically, how each of the pixel values “a” to “e” of high-resolution prediction residual samples is computed utilizing the pixel values “A” to “D” of peripheral low-resolution prediction residual samples is shown in the relevant figure.

In a block that includes samples whose residual values considerably differ from each other, the accuracy of a residual reconstructed utilizing the relevant upsampling interpolation is degraded, which degrades the quality of the decoded image. In addition, generally, boundary parts in a block are subjected to upsampling which utilizes only samples in the block, that is, does not utilize any samples in the other blocks. Therefore, a block distortion (uniquely generated in the vicinity of such block boundaries) may be generated at block boundary parts, depending on the accuracy of the interpolation.

In order to improve the accuracy of the upsampling, it is necessary to select an appropriate interpolation filter utilized to the upsampling. For this point, it may be effective to generate an optimum filter for the relevant encoding and encode corresponding filter coefficients (as additional information) together with a video signal. However, this method needs, for each sample, encoding of a coefficient that contributes to the relevant interpolation, which increases the amount of code required for the additional information and cannot implement efficient encoding.

In light of the above circumstances, an object of the present invention is to provide a video encoding method, a video decoding method, a video encoding apparatus, a video decoding apparatus, a video encoding program, and a video decoding program, so as to improve the upsampling accuracy for the prediction residual in RRU and thus improve the quality of a finally obtained image.

### Means for Solving the Problem

The present invention provides a video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:

a filter determination step that determines the interpolation filter whose filter coefficients are not encoded, by adaptively generating or selecting, for each processing region, the interpolation filter with reference to information that indicates a texture characteristic of the processing region;

a downsampling step that obtains a low-resolution prediction residual by subjecting the prediction residual signal to downsampling that utilizes the interpolation filter.

The present invention also provides a video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:

a filter determination step that determines the interpolation filter whose filter coefficients are not encoded, by adaptively generating or selecting, for each processing region, the interpolation filter with reference to motion vectors for motion-compensated prediction of the processing region and its peripheral regions;

a downsampling step that obtains a low-resolution prediction residual by subjecting the prediction residual signal to downsampling that utilizes the interpolation filter, wherein:

a status of a boundary in the processing region and its peripheral regions is estimated based on the motion vectors and the interpolation filter is generated or selected according to a result of the estimation.

The present invention also provides a video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:

a filter determination step that determines the interpolation filter whose filter coefficients are not encoded, by adaptively generating or selecting, for each processing region, the interpolation filter with reference to auxiliary information that correlates with the video;

a downsampling step that obtains a low-resolution prediction residual by subjecting the prediction residual signal to downsampling that utilizes the interpolation filter, wherein:

when the video is a video from a viewpoint among a multi-viewpoint video obtained by capturing a scene from a plurality of viewpoints, the auxiliary information is information of a video from another viewpoint.

The method may further comprise:

an auxiliary information encoding step that encodes the auxiliary information to generate auxiliary information code data; and

a multiplexing step that outputs code data in which the auxiliary information code data is multiplexed with video code data.

The present invention also provides a video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:

a filter determination step that determines the interpolation filter whose filter coefficients are not encoded, by adaptively generating or selecting, for each processing region, the interpolation filter with reference to auxiliary information that correlates with the video;

a downsampling step that obtains a low-resolution prediction residual by subject the prediction residual signal to downsampling that utilizes the interpolation filter, wherein:

the auxiliary information is a depth map that corresponds to the video.

The method may further comprise an auxiliary information generation step that generates information that indicates a status of a boundary in the processing region, as the auxiliary information, based on the depth map.

The filter determination step may generate or select the interpolation filter with reference to a video from another viewpoint in addition to the depth map.

The method may further comprise:

a depth map encoding step that encodes the depth map to generate depth map code data; and

a multiplexing step that outputs code data in which the depth map code data is multiplexed with video code data.

The present invention also provides a video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:

a filter determination step that determines the interpolation filter whose filter coefficients are not encoded, by adaptively generating or selecting, for each processing region, the interpolation filter with reference to auxiliary information that correlates with the video;

a downsampling step that obtains a low-resolution prediction residual by subjecting the prediction residual signal to downsampling that utilizes the interpolation filter, wherein:

information of the encoding target video is a depth map and the auxiliary information is information of the video at the same viewpoint, said information corresponding to the depth map.

In this case, the method may further comprise an auxiliary information generation step that generates information that indicates a status of a boundary in the processing region, as the auxiliary information, based on the information of the video at the same viewpoint.

The present invention also provides a video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:

a filter determination step that determines the interpolation filter whose filter coefficients are not decoded, by adaptively generating or selecting, for each processing region, the interpolation filter with reference to information that indicates a texture characteristic of the processing region; and

an upsampling step that obtains a high-resolution prediction residual by subjecting the prediction residual signal to upsampling that utilizes the interpolation filter.

The present invention also provides a video decoding method utilized when decoding code data of an encoding target video, wherein each frame that forms the video is divided into a plurality of processing regions, each processing region is subject to predictive decoding which is executed by subjecting a prediction residual signal to upsampling that utilizes an interpolation filter, and the method comprises:

a filter determination step that determines the interpolation filter whose filter coefficients are not decoded, by adaptively generating or selecting, for each processing region, the interpolation filter with reference to motion vectors for motion-compensated prediction of the processing region and its peripheral regions; and

an upsampling step that obtains a high-resolution prediction residual by subjecting the prediction residual signal to upsampling that utilizes the interpolation filter, wherein:

a status of a boundary in the processing region and its peripheral regions is estimated based on the motion vectors and the interpolation filter is generated or selected according to a result of the estimation.

The present invention also provides a video decoding method utilized when decoding code data of an encoding target video, wherein each frame that forms the video is divided into a plurality of processing regions, each processing region is subjected to predictive decoding which is executed by subjecting a prediction residual signal to upsampling that utilizes in interpolation filter, and the method comprises:

a filter determination step that determines the interpolation filter whose filter coefficients are not decoded, by adaptively generating or selecting, for each processing region, the interpolation filter with reference to auxiliary information that correlates with the video; and

an upsampling step that obtains a high-resolution prediction residual by subjecting the prediction residual signal to upsampling that utilizes the interpolation filter, wherein:

when the video is a video from a viewpoint among a multi-viewpoint video obtained by capturing a scene from a plurality of viewpoints, the auxiliary information is a video from another viewpoint.

In this case, the method may further comprise:

a demultiplexing step that demultiplexes the code data into auxiliary information code data and video code data; and

an auxiliary information decoding step that decodes the auxiliary information code data to generate auxiliary information;

wherein the filter determination step generates or selects the interpolation filter with reference to the decoded auxiliary information.

The present invention also provides a video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:

a filter determination step that determines the interpolation filter whose filter coefficients are not decoded, by adaptively generating or selecting, for each processing region, the interpolation filter with reference to auxiliary information that correlates with the video; and

an upsampling step that obtains a high-resolution prediction residual by subjecting the prediction residual signal to upsampling that utilizes the interpolation filter, wherein:

the auxiliary information is a depth map that corresponds to information of the video.

In this case, the method may further comprise an auxiliary information generation step that generates information that indicates a status of a boundary in the processing region, as the auxiliary information, based on the depth map.

The filter determination step may generate or select the interpolation filter with reference to a video from another viewpoint in addition to the depth map.

The method may further comprise:

a demultiplexing step that demultiplexes the code data into depth map code data and video code data; and

a depth map decoding step that decodes the depth map code data to generate a depth map.

The present invention also provides a video decoding method utilized when decoding code data of an encoding target video, wherein each frame that forms the video is divided into a plurality or processing regions, each processing region is subjected to predictive decoding which is executed by subjecting a prediction residual signal to upsampling that utilizes an interpolation filter, and the method comprises:

a filter determination step that determines the interpolation filter whose filter coefficients are not decoded, by adaptively generating or selecting, for each processing region, the interpolation filter with reference to auxiliary information that correlates with the video; and

an upsampling step that obtains a high-resolution prediction residual by subjecting the prediction residual signal to upsampling that utilizes the interpolation filter, wherein:

information of the encoding target video is a depth map and the auxiliary information is information of the video at the same viewpoint, said information corresponding to the depth map.

The present invention also provides a video encoding apparatus utilized when dividing each frame that forms an encoding target video into a plurality of processing regions and subjecting each processing region to predictive encoding which is executed by subjecting a prediction residual signal to downsampling that utilizes an interpolation filter, the apparatus comprising:

a filter determination device that determines the interpolation filter whose filter coefficients are not encoded, by adaptively generating or selecting, for each processing region, the interpolation filter with reference to auxiliary information that correlates with the video;

a downsampling device that obtains a low-resolution prediction residual by subjecting the prediction residual signal to downsampling that utilizes the interpolation filter, wherein:

when the video is a video from a viewpoint among a multi-viewpoint video obtained by capturing a scene from a plurality of viewpoint, the auxiliary information is information of a video from another viewpoint.

The present invention also provides a video decoding apparatus utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the apparatus comprises:

a filter determination device that determines the interpolation filter whose filter coefficients are not decoded, by adaptively generating or selecting, for each processing region, the interpolation filter with reference to auxiliary information that correlates with the video; and

an upsampling device that obtains a high-resolution prediction residual by subjecting the prediction residual signal to upsampling that utilizes the interpolation filter, wherein:

when the video is a video from a viewpoint among a multi-viewpoint video obtained by capturing a scene from a plurality of viewpoint, the auxiliary information is information of a video from another viewpoint.

The present invention also provides a video encoding program by which a computer executes the steps in the video encoding method.

The present invention also provides a video decoding program by which a computer executes the steps in the video decoding method.

The present invention also provides a video encoding apparatus utilized when dividing each frame that forms an encoding target video into a plurality of processing regions and subjecting each processing region to predictive encoding which is executed by subjecting a prediction residual signal to downsampling that utilizes an interpolation filter, the apparatus comprising:

a filter determination device that determines the interpolation filter whose filter coefficients are not encoded, by adaptively generating or selecting, for each processing region, the interpolation filter with reference to auxiliary information that correlates with the video;

a downsampling device that obtains a low-resolution prediction residual by subjecting the prediction residual signal to downsampling that utilizes the interpolation filter, wherein:

the auxiliary information is a depth map that corresponds to the video.

The present invention also provides a video encoding apparatus utilized when dividing each frame that forms an encoding target video into a plurality of processing regions and subjecting each processing region to predictive encoding which is executed by subjecting a prediction residual signal to downsampling that utilizes an interpolation filter, the apparatus comprising:

a filter determination device that determines the interpolation filter whose filter coefficients are not encoded, by adaptively generating or selecting, for each processing region, the interpolation filter with reference to auxiliary information that correlates with the video;

a downsampling device that obtains a low-resolution prediction residual by subjecting the prediction residual signal to downsampling that utilizes the interpolation filter, wherein:

information of the encoding target video is a depth map, and the auxiliary information is information of the video at the same viewpoint, said information corresponding to the depth map.

The present invention also provides a video decoding apparatus utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the apparatus comprises:

a filter determination device that determines the interpolation filter whose filter coefficients are not decoded, by adaptively generating or selecting, for each processing region, the interpolation filter with reference to auxiliary information that correlates with the video; and

an upsampling device that obtains a high-resolution prediction residual by subjecting the prediction residual signal to upsampling that utilizes the interpolation filter, wherein:

the auxiliary information is a depth map that corresponds to information of the video.

The present invention also provides a video decoding apparatus utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the apparatus comprises:

a filter determination device that determines the interpolation filter whose filter coefficients are not decoded, by adaptively generating or selecting, for each processing region, the interpolation filter with references to auxiliary information that correlates with the video; and

an upsampling device that obtains a high-resolution prediction residual by subjecting the prediction residual signal to upsampling that utilizes the interpolation filter, wherein:

information of the encoding target video is a depth map, and the auxiliary information is information of the video at the same viewpoint, said information corresponding to the depth map.

### Effect of the Invention

Additional information encoded together with the video signal or information that can be predicted from video by the corresponding decoding apparatus is utilized to adaptively generate or select an interpolation filter for each block to be processed pertaining to the prediction residual in the decoding. Therefore, it is possible to improve the upsampling accuracy of the prediction residual for RRU and also improve the quality of the final image.

Accordingly, the encoding efficiency can be improved utilizing RRU while sufficiently securing required image quality.

### BRIEF DESCRIPTION OF THE DRAWINGS

FIG. 1 is a block diagram that shows the structure of a video encoding apparatus 100 according to a first embodiment of the present invention.

FIG. 2 is a flowchart that shows the operation of the video encoding apparatus 100 of FIG. 1.

FIG. 3 is a diagram that shows an example of the interpolation filter utilized when a boundary crosses a block diagonally.

FIG. 4 is a diagram that shows boundary status patterns.

FIG. 5A is a diagram that shows an example of motion vectors of an encoding target block and its peripheral blocks, and a status of the boundary estimated utilizing them.

FIG. 5B is a diagram that shows another example of motion vectors of an encoding target block and its peripheral blocks, and a status of the boundary estimated utilizing them.

FIG. 6 is a block diagram that shows the structure of a video decoding apparatus 200 according to the first embodiment.

FIG. 7 is a flowchart that shows the operation of the video decoding apparatus 200 of FIG. 6.

FIG. 8 is a block diagram that shows the structure of a video encoding apparatus 100a according to a second embodiment of the present invention.

FIG. 9 is a flowchart that shows the operation of the video encoding apparatus 100a of FIG. 8.

FIG. 10 is a block diagram that shows the structure of a video decoding apparatus 200a according to the second embodiment.

FIG. 11 is a flowchart that shows the operation of the video decoding apparatus 200a of FIG. 10.

FIG. 12 is a block diagram that shows the structure of a video encoding apparatus 100b according to a third embodiment of the present invention.

FIG. 13 is a flowchart that shows the operation of the video encoding apparatus 100b of FIG. 1.

FIG. 14 is a block diagram that shows the structure of a video decoding apparatus 200b according to the third embodiment.

FIG. 15 is a flowchart that shows the operation of the video decoding apparatus 200b of FIG. 14.

FIG. 16 is a block diagram that shows an example in which boundary information is obtained based on DCT coefficients of a depth map which has been transformed and quantized.

FIG. 17 is a block diagram that shows an example of a hardware configuration of the video encoding apparatus formed using a computer and a software program.

FIG. 18 is a block diagram that shows an example of a hardware configuration of the video decoding apparatus formed using a computer and a software program.

FIG. 19 is a diagram that shows a spatial arrangement between high-resolution prediction residual samples and low-resolution prediction residual samples in conventional RRU and an example computation for the upsampling interpolation.

FIG. 20 is a diagram that shows a spatial arrangement between high-resolution prediction residual samples and low-resolution prediction residual samples in conventional RRU and another example computation for the upsampling interpolation.

### MODE FOR CARRYING OUT THE INVENTION

Below, a first embodiment of the present invention will be explained with reference to the drawings.

### First Embodiment

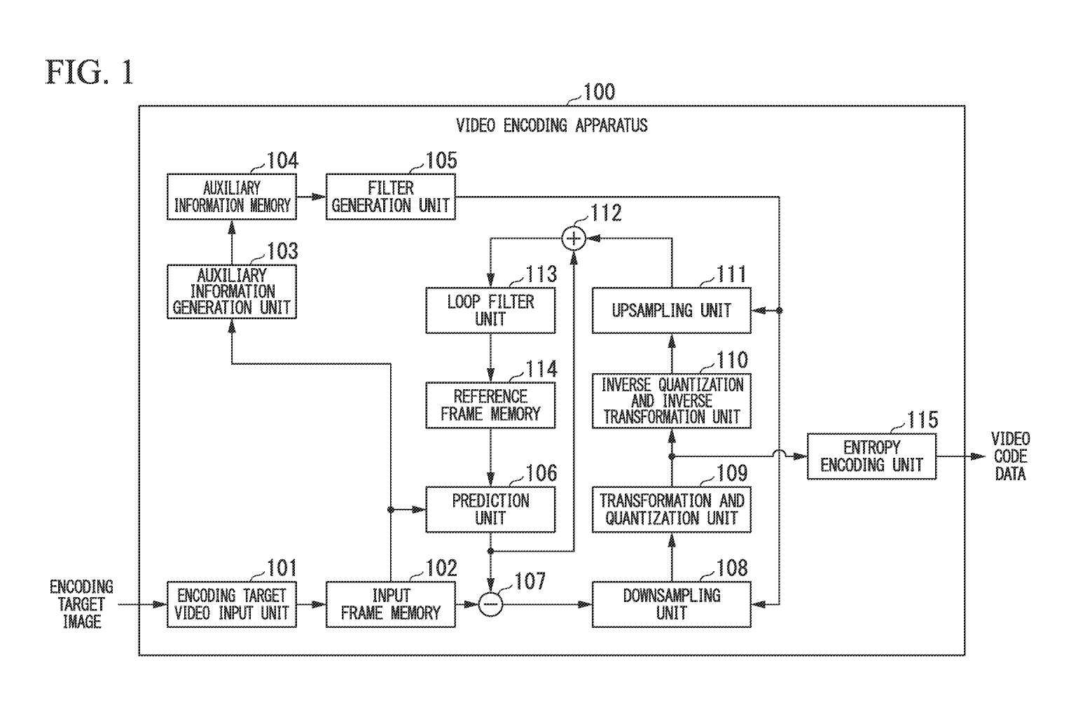

First, a video encoding apparatus according to the first embodiment of the present invention will be explained. FIG. 1 is a block diagram that shows the structure of the video encoding apparatus according to the first embodiment.

As shown in FIG. 1, the video encoding apparatus 100 has an encoding target video input unit 101, an input frame memory 102, an auxiliary information generation unit 103, an auxiliary information memory 104, a filter generation unit 105, a prediction unit 106, a subtraction unit 107, a downsampling unit 108, a transformation and quantization unit 109, an inverse quantization and inverse transformation unit 110, an upsampling unit 111, an addition unit 112, a loop filter unit 113, a reference frame memory 114, and an entropy encoding unit 115.

The encoding target video input unit 101 is utilized to input a video (image) as an encoding target into the video encoding apparatus 100. Below, this video as an encoding target is called an “encoding target video”. In particular, a frame to be processed is called an “encoding target frame” or an “encoding target image”.

The input frame memory 102 stores the input encoding target video.

The auxiliary information generation unit 103 generates auxiliary information required to generate an interpolation filter based on the encoding target frame or the encoding target image stored in the input frame memory 102. Below, this auxiliary information required for filter generation will be simply called “auxiliary information”.

The auxiliary information memory 104 stores the generated auxiliary information.

The filter generation unit 105 generates an interpolation filter utilized for downsampling and upsampling of the prediction residual with reference to the auxiliary information stored in the auxiliary information memory 104. Below, this interpolation filter utilized for downsampling and upsampling will be simply called “interpolation filter”.

In the interpolation filter generation utilizing the auxiliary information, one common filter for both the downsampling and the upsampling may be generated, or an interpolation filter may be generated for any one of the downsampling and the upsampling and a predetermined filter may be applied to the other of them, for which no filter is generated.

The prediction unit 106 subjects the encoding target image stored in the input frame memory 102 to a prediction process so as to generate a predicted image.

The subtraction unit 107 computes a difference between the encoding target image stored in the input frame memory 102 and the predicted image generated by the prediction unit 106 so as to generate a high-resolution prediction residual.

The downsampling unit 108 subjects the generated high-resolution prediction residual to downsampling utilizing the interpolation filter, so as to generate a low-resolution prediction residual.

The transformation and quantization unit 109 subjects the generated low-resolution prediction residual to relevant transformation and quantization, so as to generate quantized data.

The inverse quantization and inverse transformation unit 110 subjects the generated quantized data to corresponding inverse quantization and inverse transformation, so as to generate a decoded low-resolution prediction residual.

The upsampling unit 111 subjects the generated decoded low-resolution prediction residual to upsampling utilizing the interpolation filter, so as to generate a decoded high-resolution prediction residual.

The addition unit 112 adds the generated decoded high-resolution prediction residual to the predicted image so as to generate a decoded frame.

The loop filter unit 113 multiplies the generated decoded frame by a loop filter so as to generate a reference frame.

The reference frame memory 114 stores the generated reference frame.

The entropy encoding unit 115 subjects the quantized data to entropy encoding and outputs code data (or encoded data).

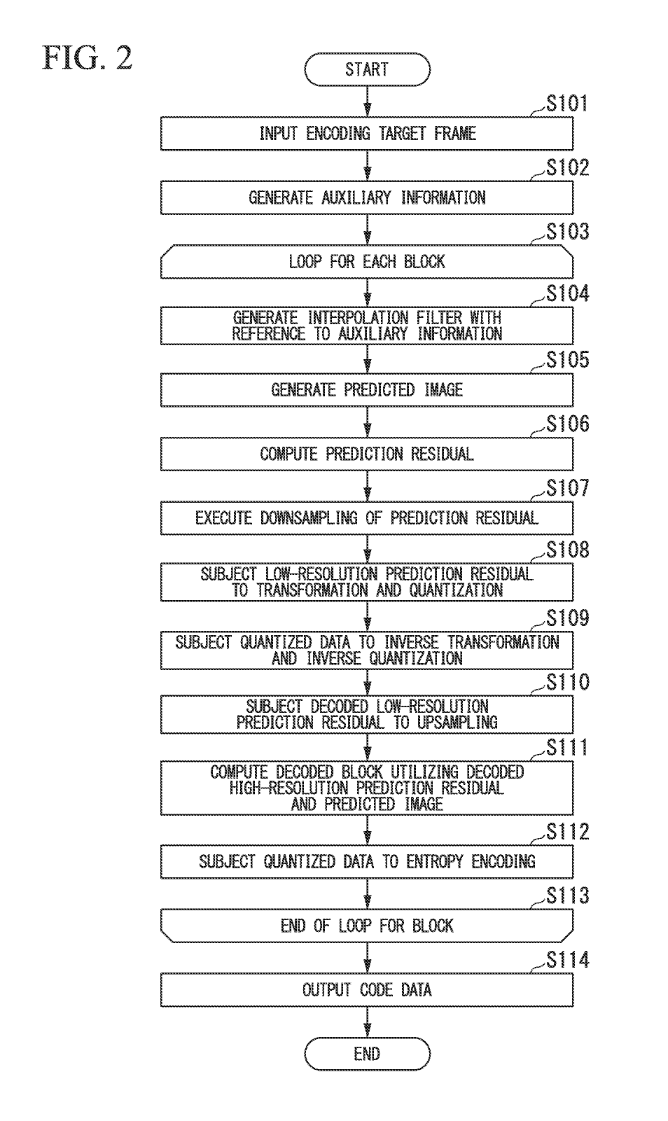

Next, referring to FIG. 2, the operation of the video encoding apparatus 100 of FIG. 1 will be explained. FIG. 2 is a flowchart that shows the operation of the video encoding apparatus 100 of FIG. 1.

Here, a process of encoding a frame in the encoding target video will be explained. The entire video is encoded by repeating the relevant process for each frame.

First, the encoding target video input unit 101 makes an encoding target frame input into the video encoding apparatus 100 and stores the frame in the input frame memory 102 (see step S101). Here, some frames in the encoding target video have been previously encoded and decoded frames thereof are stored in the reference frame memory 114.

Next, the auxiliary information generation unit 103 generates auxiliary information based on the encoding target frame.

The auxiliary information and an interpolation filter generated utilizing this information each may have any type. Additionally, the auxiliary information may be generated with reference to any information such as a previously encoded and decoded reference frame or information such as a motion vector utilized for motion-compensated prediction, in addition to the encoding target frame.

In addition, separate auxiliary information items may be utilized to generate individual interpolation filters respectively corresponding to upsampling and downsampling. In this case, the auxiliary information for a downsampling filter may be estimated with reference to any information that can be referred to in the encoding apparatus. For example, an encoding target video itself, an encoding target high-resolution prediction residual, or other information that is not encoded may be utilized.

Regarding the interpolation filter for the upsampling, estimation must be performed referring only to information that can be referred to in the relevant decoding apparatus, so as to generate or select a same interpolation filter for both the encoding apparatus and the decoding apparatus. Such information may be a predicted image, a low-resolution prediction residual, a previously-decoded reference picture or prediction information, or multiplexed code data.

Furthermore, other information may be referred to if the (same) information can be referred to by both the encoding apparatus and the decoding apparatus. For example, if another video that is not included in code data can be referred to by both the encoding and decoding apparatuses, it may be referred to.

Here, an interpolation filter for solving quality degradation at a boundary between dynamic regions or between dynamic and static regions (that will be simply called a “boundary” below), which is one of the problems peculiar to RRU, and auxiliary information utilized to generate the filter will be explained.

Generally, each block located at a boundary has a relatively large prediction error for motion-compensated prediction. Since such a block has a considerable variation in values of the prediction residual, a degradation in the decoded image (e.g., blurred boundaries of an object) tends to occur due to the downsampling and upsampling of each prediction residual. In order to prevent such degradation, it is effective to determines coefficients of the interpolation filter in accordance with the state of the boundaries.

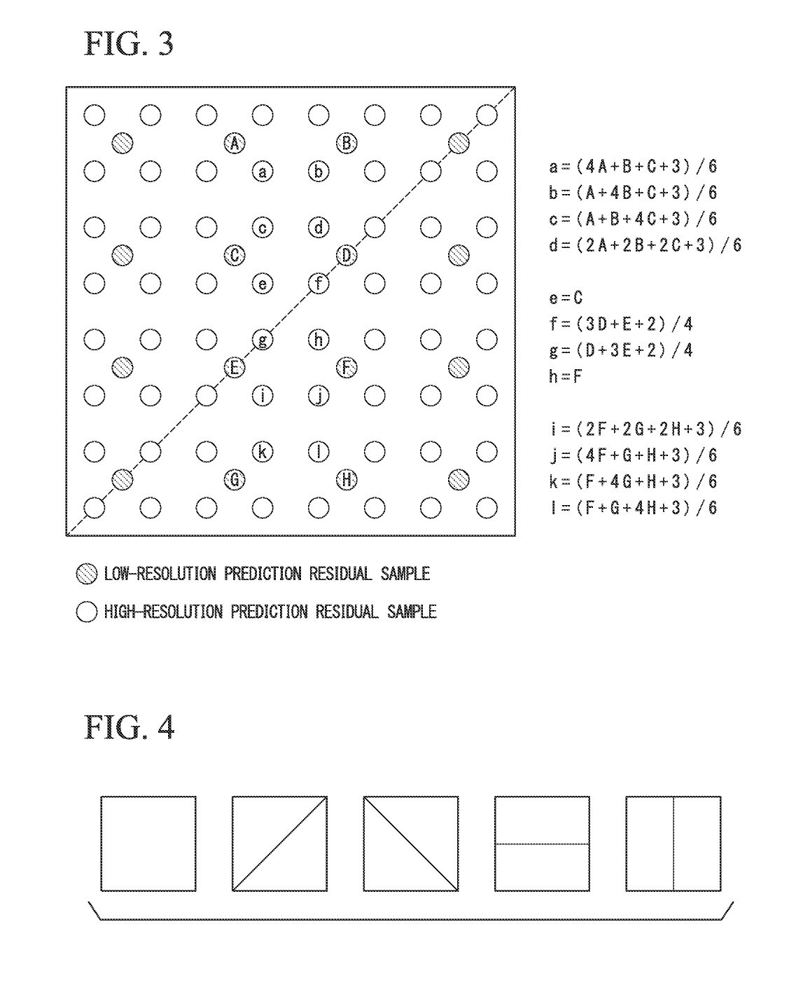

FIG. 3 shows an example of the interpolation filter utilized when a boundary indicated by a broken line crosses a block diagonally.

In FIG. 3, white circles show the arrangement of the high-resolution prediction residual samples, and shaded circles the arrangement of the low-resolution prediction residual samples. Additionally, characters “a” to “I” and “A” to “H” in some circles shows examples of the pixel value. Specifically, how each of the pixel values “a” to “I” of high-resolution prediction residual samples is computed utilizing the pixel values “A” to “H” of peripheral low-resolution prediction residual samples is shown in the relevant figure.

In the shown example, in the upper region above the boundary, interpolation is performed utilizing only the samples in the upper region (i.e., without utilizing the samples in the lower region). Interpolation in the lower region is performed in a similar manner. Additionally, in a region located at the boundary, interpolation is performed utilizing only the samples on the boundary.

As the auxiliary information utilized to generate such an interpolation filter, any information that indicates a status of the boundary is utilized. The status of the boundary may be strictly represented for each pixel or presented utilizing the closest one of predetermined rough patterns as shown in FIG. 4 (that shows examples of the boundary pattern).

In addition, any method may be employed to estimate the boundary. For example, an outline obtained by subjecting the encoding target frame to an outline extracting process may be estimated to be a boundary. The auxiliary information in this case may be an image itself of the outline or coordinates that indicate each pixel which forms the outline.

In the decoding process, no high-resolution image of the outline cannot be obtained from the low-resolution prediction residual itself. However, such a high-resolution image can be estimated utilizing an image of the outline in a previously-decoded block or frame or may be estimated utilizing a predicted image. For this process, each block having a high prediction accuracy may be subjected to the estimation utilizing a predicted image while each block having a low prediction accuracy may be subjected to estimation employing another method.

In another method, the status of the boundary may be estimated utilizing motion vectors of the encoding target block and its peripheral blocks, which are used in motion-compensated prediction.

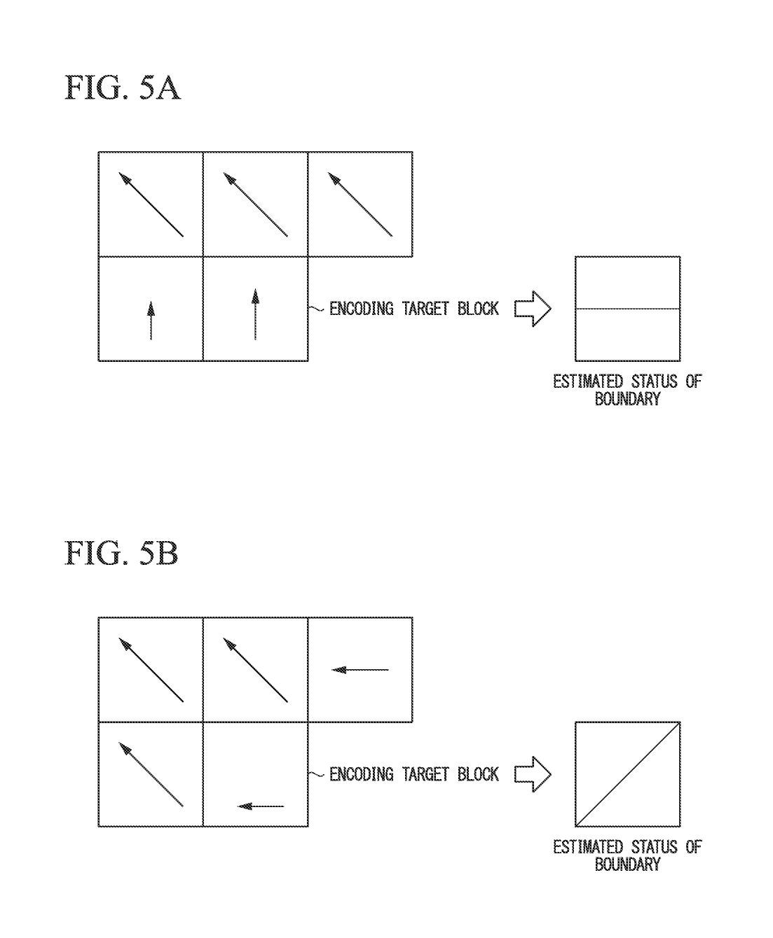

FIGS. 5A and 5B show examples of motion vectors of an encoding target block and its peripheral blocks, and a status of the boundary estimated utilizing them. In the figures, arrows indicate motion vectors of the individual blocks. In FIG. 5A, a boundary in the horizontal direction is estimated. In FIG. 5B, a boundary in the right-upward diagonal direction is estimated.

In another method, a boundary may be estimated due to object extraction from the entire video, in contrast to the above-described local boundary status estimation. This method may employ any process such as image segmentation.

In another method, some boundary status patterns are predetermined and distinguished from each other utilizing the identification number. A pattern closest to the relevant boundary, which is estimated by any method, is selected and the identification number thereof may be utilized as the auxiliary information.

There is another problem in which when a single interpolation filter is applied to all encoding target regions which have various characteristics, the relevant quality may be considerably degraded. For such a problem, an optimum interpolation filter may be estimated based on a characteristic for the texture of the encoding target block.

For example, an appropriate filter may be generated or selected in accordance with a characteristic such that the texture has a smooth gradation, is uniform, includes an edge, or is complex and has many high-frequency components. If the texture has a smooth gradation, it is assumed that the residual also has a smooth state and a filter utilized to perform smooth interpolation (e.g., bilinear filter) may be generated. If the texture includes a strong edge, it is assumed that the residual therefor also has an edge and an interpolation filter that secures the edge can be estimated. The auxiliary information utilized to generate such an interpolation filter may be a predicted image of the encoding target block or previously-encoded peripheral images.

In addition, a combination of boundary information and a texture characteristic may be utilized. For example, an interpolation filter determined based on a boundary region pattern is assigned to a boundary region while an interpolation filter determined based on a texture characteristic is assigned to a non-boundary region.

Specific filter coefficients for the interpolation filter may be selected based on a predetermined coefficient pattern or computed based on a function (as performed for a bilateral filter).

Generally, boundary parts in a block are subjected to upsampling which utilizes only samples in the block, that is, does not utilize any samples in the other blocks. Therefore, a block distortion may be generated at block boundary parts, depending on the accuracy of the interpolation. When performing the interpolation in each of two blocks, one of the blocks may perform a sampling across an object boundary (with respect to the previously-described problem) and the other's sampling may not cross this boundary or may cross another object boundary. In this case, for the pixels in the block boundary parts, residual values computed in the individual blocks show different degradation states, which tends to cause a block distortion.

For this problem, such a block which tends to produce a block distortion may be subjected to an interpolation utilizing the samples in another block, or an extrapolation filter may be utilized depending on a situation.

As shown in the above-described examples, the employed filter may be determined utilizing any method. Whether or not the samples outside the present block can be used or an extrapolation filter can be used may be estimated based on a video signal, and another additional information item may be encoded. Additionally, for the above problem, an interpolation filter that takes into account the above-described object boundary may be utilized to reduce blurs in block boundary parts and thus indirectly reduce them.

Although the examples of the interpolation filter, the auxiliary information, and the estimation methods therefor have been explained above, the present invention is not limited to the examples and any other interpolation filter, auxiliary information, and estimation methods may be employed.

Returning to FIG. 2, after the auxiliary information generation, the encoding target frame is divided into encoding target blocks and each block is subjected to a routine of encoding a video signal of the encoding target frame (see step S103). That is, the following steps S104 to S112 are repeatedly executed until all blocks of the relevant frame have been processed sequentially.

In the operation repeated for each block, first, the filter generation unit 105 generates an interpolation filter with reference to the auxiliary information (see step S104).

Examples of the generated interpolation filter were described above. The relevant filter generation may determine the filter coefficients sequentially or select one of predetermined filter patterns.

Next, the prediction unit 106 performs a prediction process utilizing the encoding target frame and the reference frame so as to generate a predicted image (see step S105).

It is possible to employ any prediction method by which the relevant decoding apparatus can accurately generate a predicted image by utilizing prediction information or the like. In ordinary video encoding, a prediction method such as intra-picture prediction or motion compensation is employed. Generally, prediction information utilized in such a method is encoded and multiplexed with video code data.

Next, the subtraction unit 107 computes a difference between the predicted image and the encoding target block so as to generate a prediction residual (see step S106).

When the prediction residual generation is completed, the downsampling unit 108 utilizes the interpolation filter to execute the downsampling of the prediction residual, so as to generate a low-resolution prediction residual (see step S107).

Then the transformation and quantization unit 109 subjects the low-resolution prediction residual to the transformation and quantization so as to generate quantized data (see step S108). This transformation and quantization may be executed in any method by which the decoding apparatus can obtain accurate results of corresponding inverse transformation and inverse quantization.

When the transformation and quantization is completed, the inverse quantization and inverse transformation unit 110 subjects the quantized data to the inverse quantization and inverse transformation so as to generate a decoded low-resolution prediction residual (see step S109).

Next, the upsampling unit 111 subjects the decoded low-resolution prediction residual to upsampling utilizing the interpolation filter, so as to generate a decoded high-resolution prediction residual (see step S110). Preferably, the interpolation filter utilized in this process is not the same filter utilized in the downsampling but a filter that is newly generated by any method as described above. However, if encoding noises can be permitted, the same filter may be utilized.

When the upsampling is completed, the addition unit 112 adds the decoded low-resolution prediction residual to the predicted image so as to generate a decoded block. The loop filter unit 113 then multiplies the generated decoded frame by a loop filter and stores the product as a block of the reference frame in the reference frame memory 114 (see step S111).

The multiplication utilizing the loop filter may not be performed if it is not necessary. However, in general video encoding, encoding noises are removed utilizing a deblocking filter or another filter. For this purpose, a filter utilized to remove degraded information due to RRU may be employed. In addition, Such a loop filter may be adaptively generated through a procedure similar to a procedure utilized to generate an upsampling filter.

Next, the entropy encoding unit 115 subjects the quantized data to entropy encoding so as to generate code data (see step S112).

After all blocks are processed (see step S113), video code data is output (see step S114).

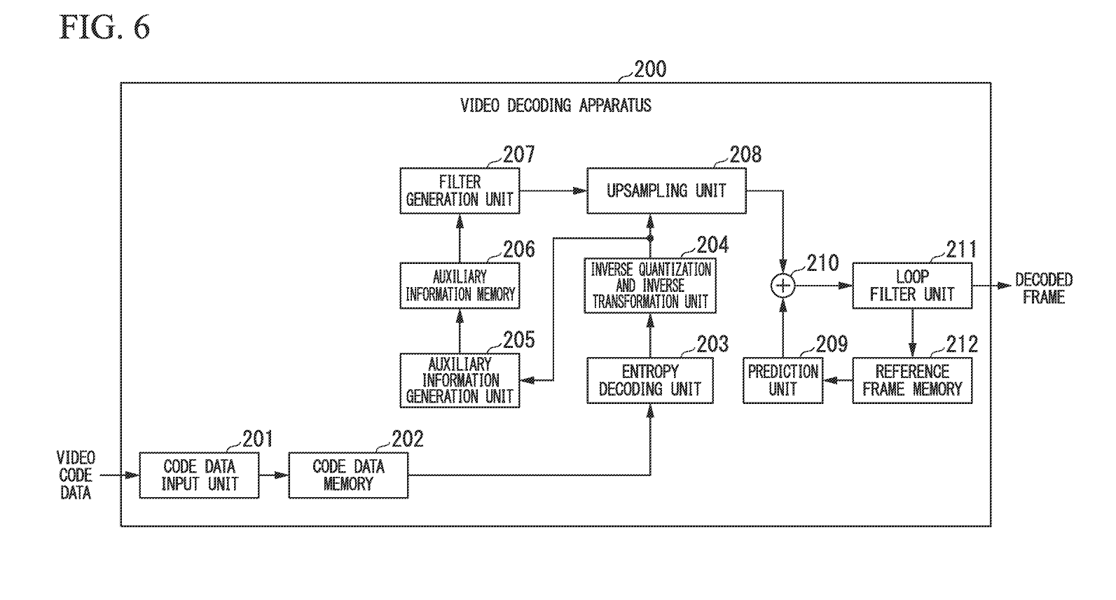

Below, a video decoding apparatus according to the first embodiment will be explained. FIG. 6 is a block diagram that shows the structure of the video decoding apparatus according to the first embodiment.

As shown in FIG. 6, the video decoding apparatus 200 has a code data input unit 201, a code data memory 202, an entropy decoding unit 203, an inverse quantization and transformation unit 204, an auxiliary information generation unit 205, an auxiliary information memory 206, a filter generation unit 207, an upsampling unit 208, a prediction unit 209, an addition unit 210, a loop filter unit 211, and a reference frame memory 212.

The code data input unit 201 is utilized to input video code data as a decoding target into the video decoding apparatus 200. Below, this video code data as a decoding target is called a “decoding target video code data”. In particular, a frame to be processed is called a “decoding target frame” or a “decoding target image”.

The code data memory 202 stores the input decoding target video code data.

The entropy decoding unit 203 subjects the code data of the decoding target frame to entropy decoding so as to generate quantized data. The inverse quantization and inverse transformation unit 204 subjects the generated quantized data to relevant inverse quantization and inverse transformation so as to generate a decoded low-resolution prediction residual.

Similar to the above explanation pertaining to the encoding apparatus, the auxiliary information generation unit 205 generates auxiliary information based on the generated decoded low-resolution prediction residual or a reference frame, and prediction information, or other information.

The auxiliary information memory 206 stores the generated auxiliary information.

The filter generation unit 207 generates an interpolation filter utilized for upsampling of the prediction residual with reference to the auxiliary information.

The upsampling unit 208 subjects the decoded low-resolution prediction residual to upsampling utilizing the interpolation filter, so as to generate a decoded high-resolution prediction residual.

The prediction unit 209 subjects the decoding target image to a prediction process referring to prediction information or the like, so as to generate a predicted image.

The addition unit 210 adds the generated decoded high-resolution prediction residual to the predicted image so as to generate a decoded frame.

The loop filter unit 211 multiplies the generated decoded frame by a loop filter so as to generate a reference frame.

The reference frame memory 212 stores the generated reference frame.

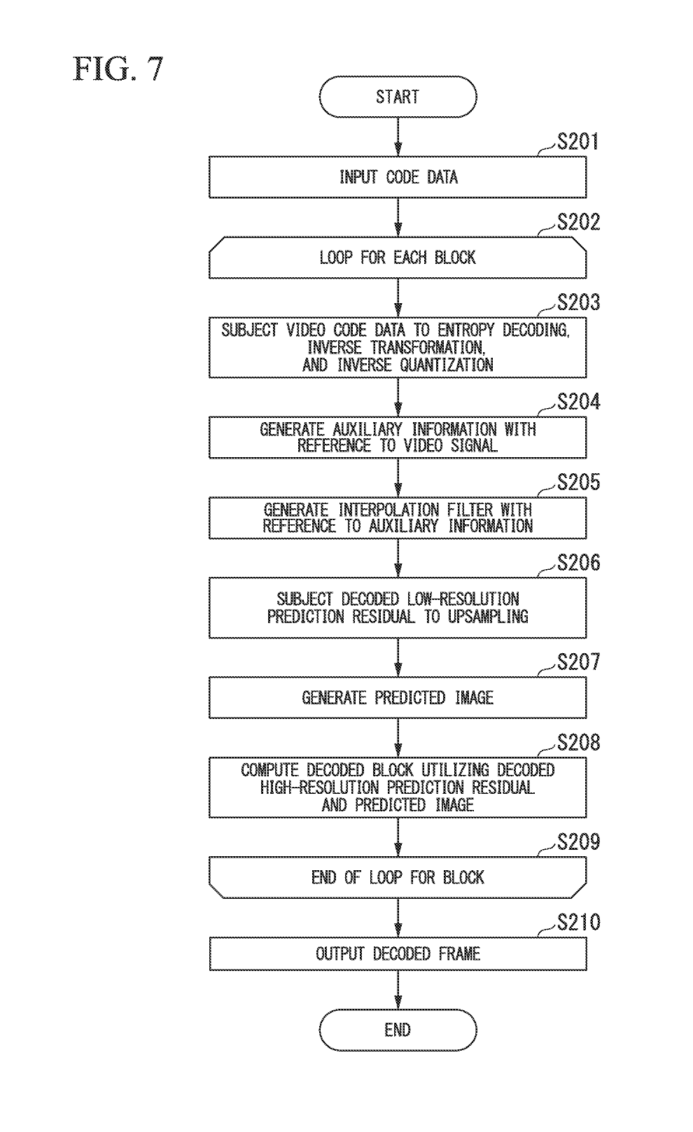

Next, referring to FIG. 7, the operation of the video decoding apparatus 200 of FIG. 6 will be explained. FIG. 7 is a flowchart that shows the operation of the video decoding apparatus 200 of FIG. 6.

Here, a process of decoding a frame in the code data will be explained. The entire video is decoded by repeating the relevant process for each frame.

First, the code data input unit 201 makes video code data input into the video decoding apparatus 200 and stores the data in the code data memory 202 (see step S201). Here, some frames in the decoding target video have been previously decoded and are stored in the reference frame memory 212.

Next, the decoding target frame is divided into target blocks and each block is subjected to a routine of decoding a video signal of the decoding target frame (see step S202). That is, the following steps S203 to S208 are repeatedly executed until all blocks of the relevant frame have been processed sequentially.

In the operation repeated for each block, first, the entropy decoding unit 203 subjects the code data to entropy decoding, and the inverse quantization and inverse transformation unit 204 subjects the relevant result to the inverse quantization and inverse transformation so as to generate a decoded low-resolution prediction residual (see step S203).

Next, the auxiliary information generation unit 205 generates auxiliary information required to generate an interpolation filter, based on the generated decoded low-resolution prediction residual or a reference frame, and prediction information (or other information), and stores the generated information in the auxiliary information memory 206 (see step S204).

After generating the auxiliary information, the filter generation unit 207 generates an interpolation filter with reference to the auxiliary information (see step S205).

The upsampling unit 208 then subjects the decoded low-resolution prediction residual to the upsampling so as to generate a decoded high-resolution prediction residual (see step S206).

Next, the prediction unit 209 performs a prediction process utilizing the decoding target frame and a reference frame so as to generate a predicted image (see step S207).

The addition unit 210 then adds the decoded high-resolution prediction residual to the predicted image, the loop filter unit 211 multiplies the sum by a loop filter, and the result thereof is stored as a reference block in the reference frame memory 212.

Lastly, when all blocks have been processed (see step S209), the result thereof is output as a decoded frame (see step S210).

Next, a second embodiment of the present invention will be explained with reference to the drawings.

### Second Embodiment

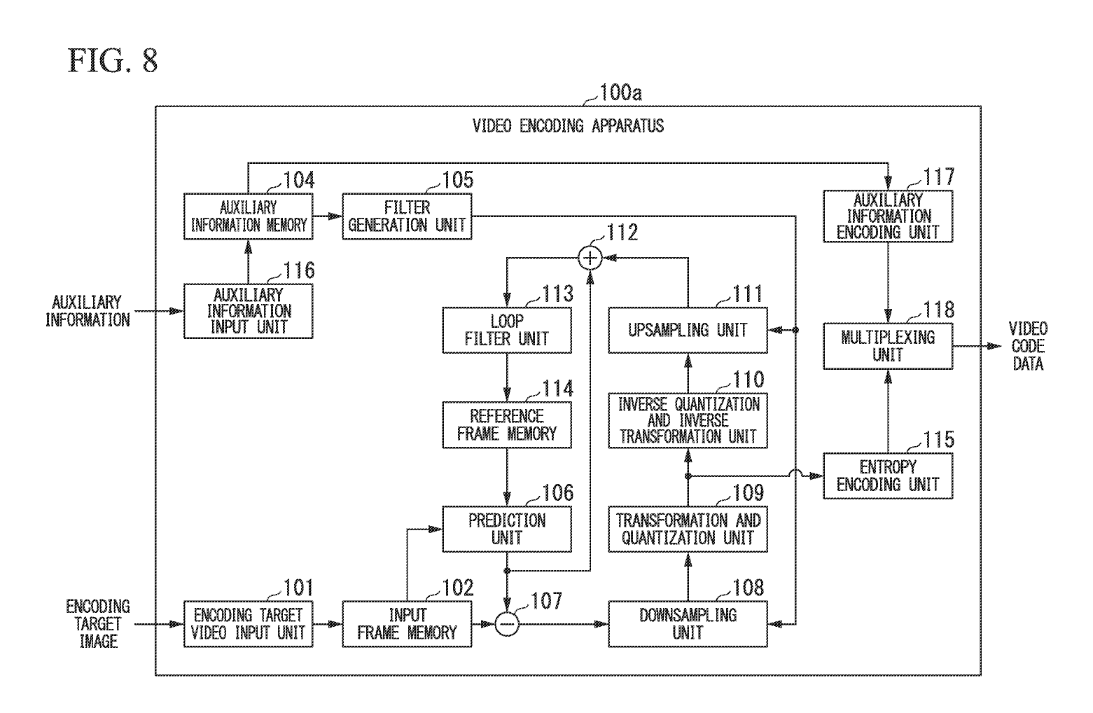

FIG. 8 is a block diagram that shows the structure of a video encoding apparatus 100a according to the second embodiment of the present invention. In FIG. 8, parts identical to those in FIG. 1 are given identical reference numerals and explanations thereof are omitted here.

In comparison with the apparatus of FIG. 1, the apparatus of FIG. 8 has distinctive features such that an auxiliary information input unit 116 is provided in place of the storage unit 103, and an auxiliary information encoding unit 117 and a multiplexing unit 118 are newly provided.

The auxiliary information input unit 116 is utilized to input auxiliary information required to generate an interpolation filter into the video encoding apparatus 100a.

The auxiliary information encoding unit 117 encodes the input auxiliary information so as to generate auxiliary information code data.

The multiplexing unit 118 multiplexes the auxiliary information code data with the video code data and outputs the multiplexed result.

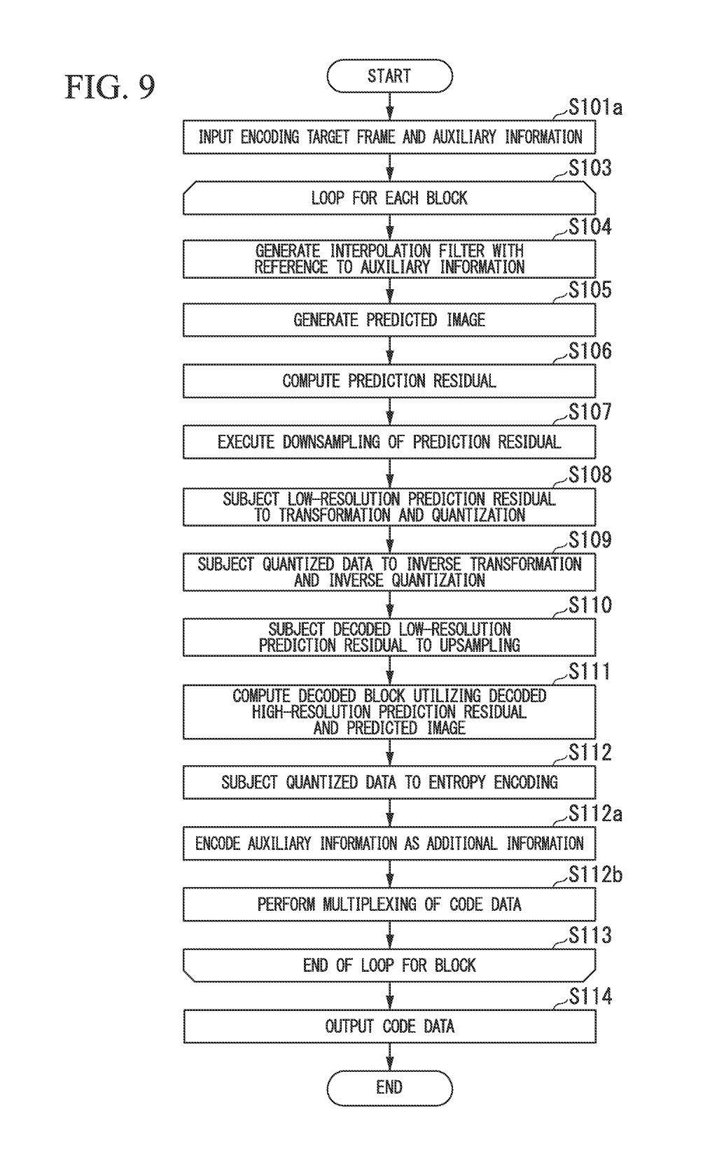

Next, referring to FIG. 9, the operation of the video encoding apparatus 100a of FIG. 8 will be explained. FIG. 9 is a flowchart that shows the operation of the video encoding apparatus 100a of FIG. 8.

In FIG. 9, instead of the auxiliary information generating process in the first embodiment, auxiliary information is received from an external device and is utilized for filter generation, and the auxiliary information is encoded and multiplexed with the video code data so as to produce a video signal.

In FIG. 9, steps identical to those in FIG. 2 are given identical step numbers and explanations thereof are omitted here.

First, the encoding target video input unit 101 makes an encoding target frame input into the video encoding apparatus 100a and stores the frame in the input frame memory 102. In parallel to this process, the auxiliary information input unit 116 receives auxiliary information and stores it in the auxiliary information memory 104 (see step S101a).

Here, some frames in the encoding target video have been previously encoded and decoded frames thereof are stored in the reference frame memory 114.

The auxiliary information received here may be any information by which the relevant decoding apparatus can generate a corresponding type of the interpolation filter. As shown in the examples for the first embodiment, it may be generated utilizing video information or prediction information, or it may be generated using other information having any correlation with the encoding target video or information generated utilizing such information.

For example, when the encoding target video is a video at one viewpoint contained in a multi-viewpoint video obtained by capturing a scene from a plurality of viewpoints, the encoding target video spatially correlates with the relevant video from another viewpoint. Therefore, auxiliary information for the encoding target video can be obtained utilizing such video from another viewpoint. In this case, the auxiliary information may be obtained by a method similar to that explained in the first embodiment or any other method.

In addition, the auxiliary information that is encoded and multiplexed with the video code data may be auxiliary information obtained for the encoding target video data, or a video itself which was obtained from another viewpoint may be encoded and utilized as the auxiliary information. In another example, image information having a value that depends on an object may be utilized as the auxiliary information (e.g., a normal map or a temperature image).

Additionally, some filter patterns and identification numbers therefor may be determined in advance and the identification number itself of a filter to be selected among them may be utilized as the auxiliary information. In this case, the filter selection may be performed by any method. Specifically, the filter to be selected may be determined utilizing a method similar to any one of the above-described methods. In another example, encoding and decoding are executed using a candidate filter for each encoding target block, the quality of the obtained decoded block is evaluated, and a filter that provides the highest quality is selected.

In addition, filter coefficients obtained by any method themselves may be utilized as auxiliary information.

Furthermore, if filter coefficients are determined based on a function (e.g., those of a bilateral filter), a parameter of the function may be utilized as the auxiliary information.

When generation of noises (e.g. encoding noise) is permitted, the auxiliary information utilized for filter generation may be information that has not been encoded. However, in order to further improve the encoding quality, it is possible to employ information that has been encoded and then decoded though an encoding procedure and a decoding procedure explained later. The encoding and decoding of the auxiliary information may be executed in the video encoding apparatus or performed in another process executed before encoding the encoding target video.

Next, the encoding target frame is divided into encoding target blocks and each block is subjected to a routine of encoding a video signal of the encoding target frame (see step S103). That is, the following steps S104 to S112b are repeatedly executed until all blocks of the relevant frame have been processed sequentially.

Here, steps S104 to S112 are executed in a manner similar to the corresponding steps in the flowchart of FIG. 2.

Next, the above-described auxiliary information is encoded (see step S112a) and then multiplexed with the video code data so as to generated code data (see step S112b).

For this encoding, any method may be employed if accurate decoding can be performed in the relevant decoding apparatus. However, as described above, if encoding and decoding of the auxiliary information have previously been performed to generate a filter, previously-encoded auxiliary information may be directly utilized (i.e., without further encoding the decoded data).

After all blocks are processed (see step S113), video code data is output (see step S114).

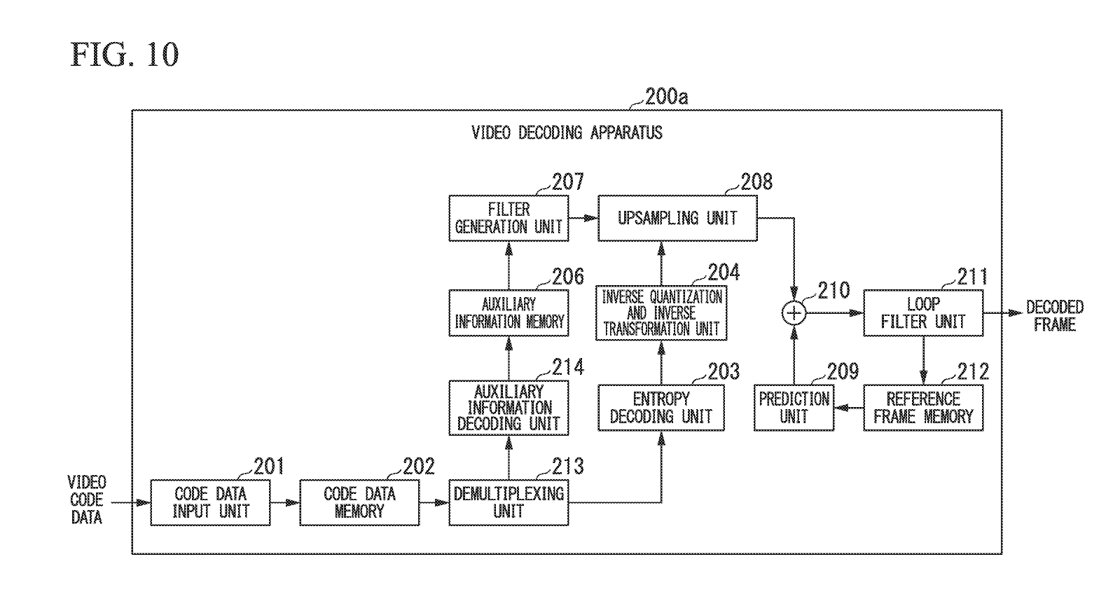

Below, a video decoding apparatus according to the second embodiment will be explained. FIG. 10 is a block diagram that shows the structure of the video decoding apparatus according to the second embodiment. In FIG. 10, parts identical to those in FIG. 6 are given identical reference numerals and explanations thereof are omitted here.

In comparison with the apparatus of FIG. 6, the apparatus of FIG. 10 has distinctive features such that a demultiplexing unit 213 is newly provided, and an auxiliary information decoding unit 214 is provided in place of the auxiliary information generation unit 205.

The demultiplexing unit 213 demultiplexes the code data into auxiliary information code data and video code data.

The auxiliary information decoding unit 214 decodes the auxiliary information code data so as to generate the auxiliary information.

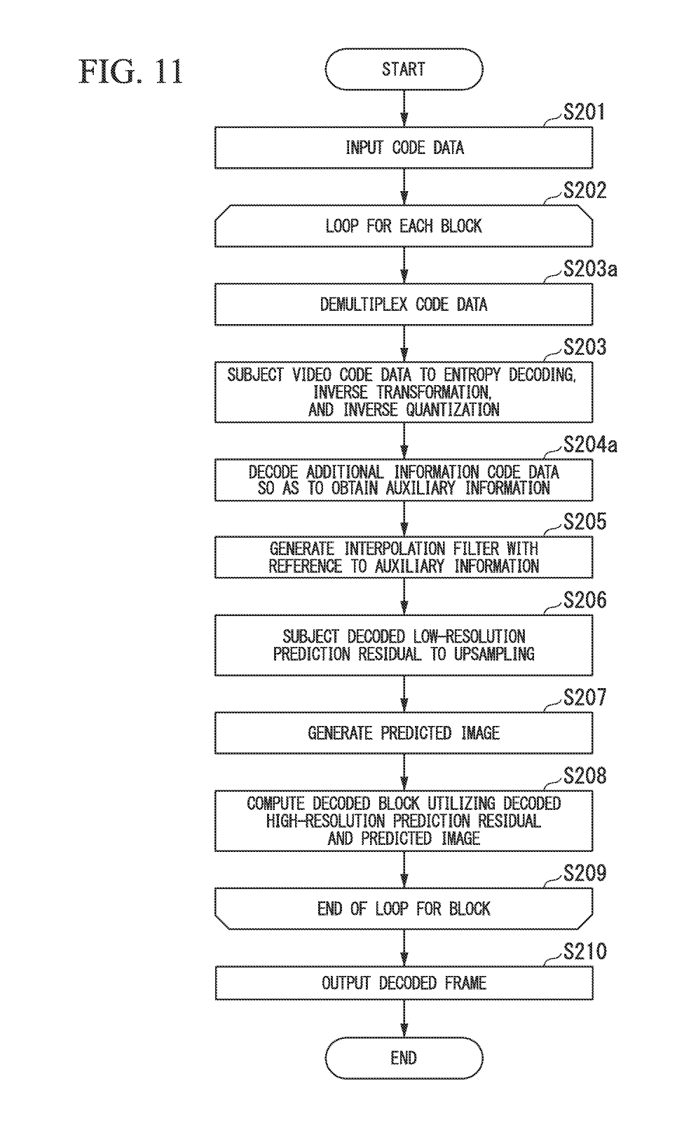

Next, referring to FIG. 11, the operation of the video decoding apparatus 200a of FIG. 10 will be explained. FIG. 11 is a flowchart that shows the operation of the video decoding apparatus 200a of FIG. 10.

Here, a process of decoding a frame in the code data will be explained. The entire video is decoded by repeating the relevant process for each frame.

In FIG. 11, instead of the video code data in the first embodiment, code data in which video code data and auxiliary information code data are multiplexed is input into the video decoding apparatus 200a and is demultiplexed so as to decode the auxiliary information (instead of generating auxiliary information). The decoded auxiliary information is utilized to generate a filter.

In FIG. 11, steps identical to those in FIG. 7 are given identical step numbers and explanations thereof are omitted here.

First, the code data input unit 201 makes video code data input into the video decoding apparatus 200a and stores the data in the code data memory 202 (see step S201). Here, some frames in the decoding target video have been previously decoded and are stored in the reference frame memory 212.

Next, the decoding target frame is divided into target blocks and each block is subjected to a routine of decoding a video signal of the decoding target frame (see step S202). That is, the following steps S203 to S208 are repeatedly executed until all blocks of the relevant frame have been processed sequentially.

In the operation repeated for each block, first, the demultiplexing unit 213 demultiplexes the input video code data into video code data and auxiliary information code data (see step S203a).

The entropy decoding unit 203 then subjects the video code data to entropy decoding, and the inverse quantization and inverse transformation unit 204 subjects the relevant result to the inverse quantization and inverse transformation so as to generate a decoded low-resolution prediction residual (see step S203).

Next, the auxiliary information decoding unit 214 performs decoding of the auxiliary information and stores the decoded result in the auxiliary information memory 206 (see step S204a).

The following steps S205 to S210 are executed in a manner similar to the corresponding steps in FIG. 7.

In the second embodiment, the auxiliary information code data and the video code data are multiplexed for each block to be processed. However, they may be separate code data items for another processing unit such as a picture. In addition, the encoding apparatus does not need to perform the encoding and multiplexing of auxiliary information if the relevant decoding apparatus can obtain equivalent auxiliary information.

Next, a third embodiment of the present invention will be explained with reference to the drawings.

### Third Embodiment

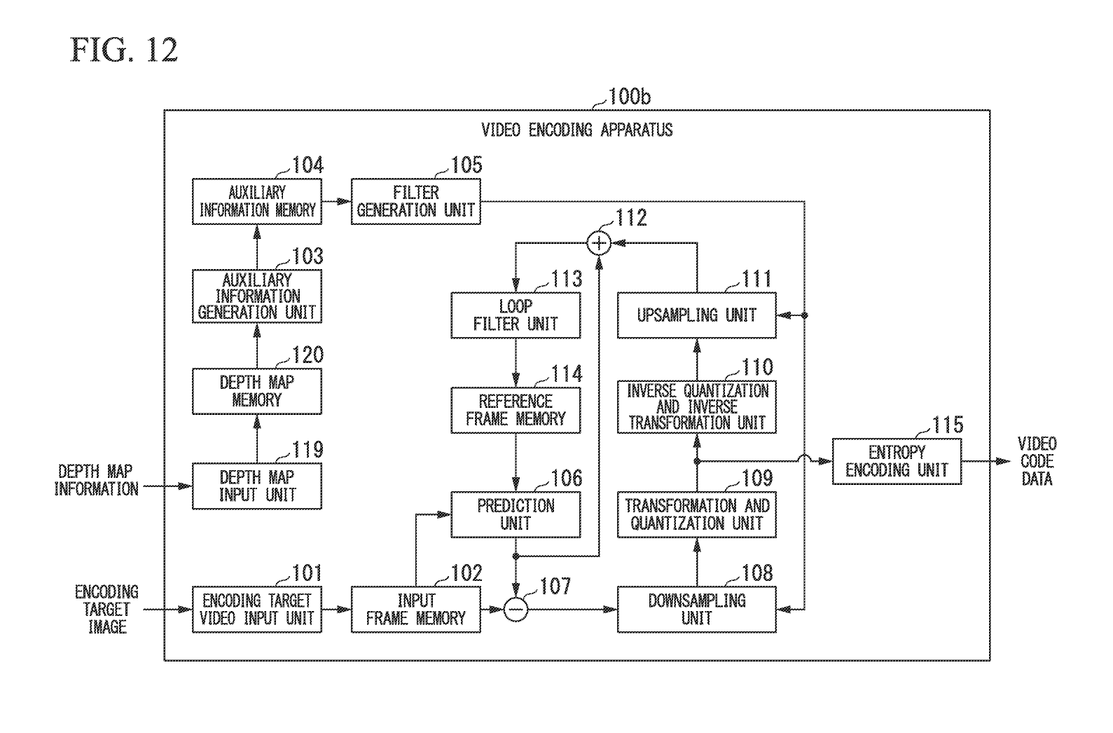

FIG. 12 is a block diagram that shows the structure of a video encoding apparatus 100b according to the third embodiment of the present invention. In FIG. 12, parts identical to those in FIG. 1 are given identical reference numerals and explanations thereof are omitted here.

In comparison with the apparatus of FIG. 1, the apparatus of FIG. 12 has distinctive features such that a depth map input unit 119 and a depth map memory 120 are newly provided, and the auxiliary information generation unit 103 generates the auxiliary information utilizing a depth map instead of the encoding target frame.

The depth map input unit 119 is utilized to input a depth map (information), which is referred to in order to generate an interpolation filter, into the video encoding apparatus 100b. The depth map input here represents a depth value of each object captured at each pixel in each frame of the encoding target video.

The depth map memory 120 stores the input depth map.

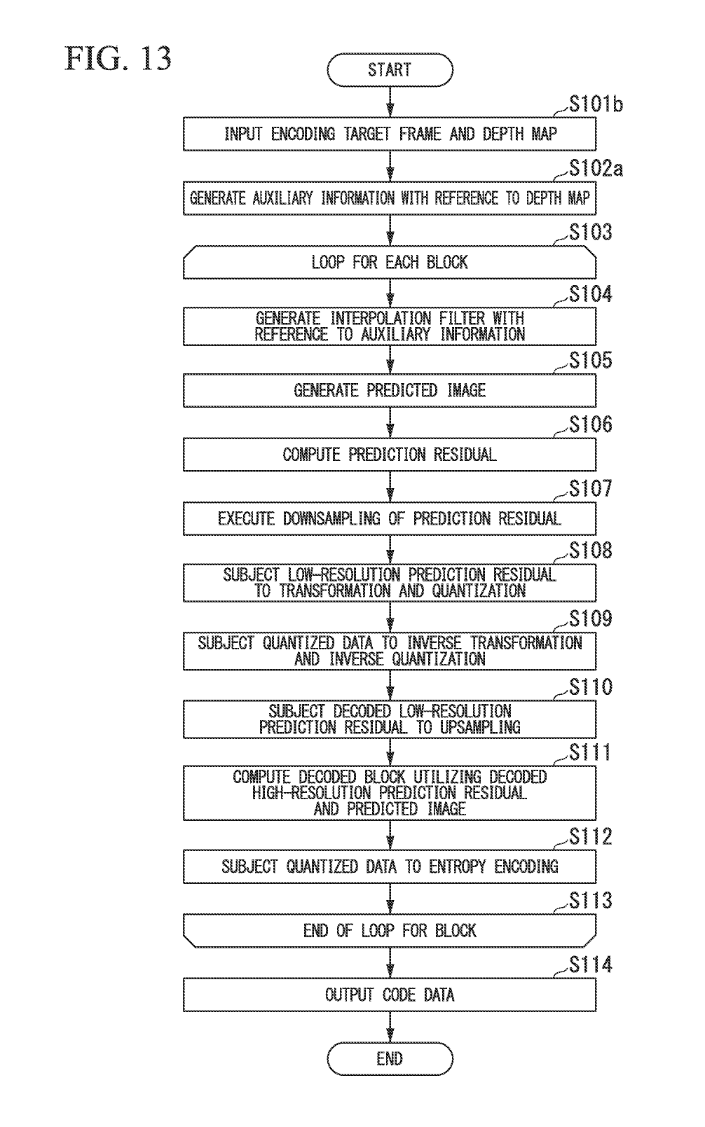

Next, referring to FIG. 13, the operation of the video encoding apparatus 100b of FIG. 12 will be explained. FIG. 13 is a flowchart that shows the operation of the video encoding apparatus 100b of FIG. 12.

In FIG. 13, instead of the auxiliary information generation referring to video information in the first embodiment, a depth map is received from an external device and is utilized to generate the auxiliary information.

In FIG. 13, steps identical to those in FIG. 2 are given identical step numbers and explanations thereof are omitted here.

First, the encoding target video input unit 101 makes an encoding target frame input into the video encoding apparatus 100b and stores the frame in the input frame memory 102. In parallel to this process, the depth map input unit 119 receives a depth map and stores it in the depth map memory 120 (see step S101b).

Here, some frames in the encoding target video have been previously encoded and decoded frames thereof are stored in the reference frame memory 114, where corresponding depth maps are also stored in the depth map memory 120.

Additionally, in the second embodiment, input encoding target frames are encoded sequentially, where the input order does not need to always coincide with the encoding order. When the input order does not coincide with the encoding order, a previously-input frame is stored in the input frame memory 102 until the frame to be encoded next is input.

When the encoding target frame stored in the input frame memory 102 has been processed by an encoding method explained later, this frame may be deleted in the input frame memory 102. However, the depth map stored in the depth map memory 120 is stored until a decoded frame of the corresponding encoding target frame is deleted in the reference frame memory 114.

In order to prevent generation of encoding or other noises, it is preferable that the depth map input in step S101b coincides with a depth map obtained by the relevant decoding apparatus. For example, when the depth map is encoded so as to generate the code data together with video data, a depth map which has been encoded and then decoded is utilized for the relevant video encoding.

Other examples of the depth map that can be obtained by the decoding apparatus include a depth map that is synthesized utilizing a previously-encoded depth map from another viewpoint, and a depth map that is estimated due to stereo matching or the like based on a decoded result for a group of previously-encoded images from other viewpoints.

However, when the generation of encoding noises is permitted, a depth map which has not been encoded can be employed.

Next, the auxiliary information generation unit 103 generates auxiliary information utilized to generate an interpolation filter, with reference to the depth map (see step S102a).

The auxiliary information generated here, an estimation therefor, and the generated interpolation filter each may have any type. For example, if boundary information whose example was explained in the first embodiment is utilized as auxiliary information, a similar estimation may be performed based on outline information about the depth map (instead of video), a motion vector utilized to encode the depth map, or the like.

Generally, depth values of the pixels which form an object are relatively continuous, and depth values of the pixels at a boundary between different objects are discrete in most cases. Therefore, when the boundary information is obtained based on outline information or a motion vector of the depth map, accurate boundary information can be obtained without being affected by the texture of the relevant video. Accordingly, it is possible to accurately generate an interpolation filter.

In addition, instead of the estimation of a local boundary status, an object boundary may be extracted based on the entire depth map. In this case, each object may be extracted in consideration of the above-described continuity or a method such as an image segmentation may be employed.

Additionally, the auxiliary information may be the depth value itself of each pixel in the relevant block, an arithmetic value based thereon, or an identification number of a filter to be selected.

For example, an average of depth values may be referred to so as to perform switching whether an interpolation filter is adaptively generated or an existing filter is utilized.

For each block having a small average depth value, disparity with respect to a video captured from another viewpoint is very small and thus the accuracy for disparity-compensated prediction is high. Also in this case, since the distance from the camera is large, the amount of movement of the object is small and thus the motion-compensated prediction also has a relatively high accuracy in most cases. Therefore, since the possibility that the prediction residual becomes very small is high, the possibility that an interpolation utilizing a simple bilinear filter produces a preferable decoding result is also high. On the other hand, each block having large depth values has a reverse effect and an adaptive interpolation filter is effective in most cases.

In addition, the interpolation filter may be generated with reference to a video from another viewpoint in a manner such that a highly accurate correspondence relationship between the encoding target video and a previously-decoded video from another viewpoint is obtained utilizing a depth map.

Specific filter coefficients may be selected based on a predetermined coefficient pattern or computed based on a function (as performed for a bilateral filter).

For example, a cross bilateral filter function may be utilized, where luminance values referred to (for a bilateral filter) are not the luminance values of the encoding target video, but the luminance values of the depth map. In another example, a function referring to both the video and the depth map, or a function referring to other information alignment may be utilized.

Examples of the interpolation filter, the auxiliary information, and the estimation methods therefor have been explained above. However, these items are not limited to such examples and any other interpolation filter, auxiliary information, and estimation methods may be employed.

The following steps S103 to S114 are performed in a manner similar to the corresponding steps in FIG. 2.

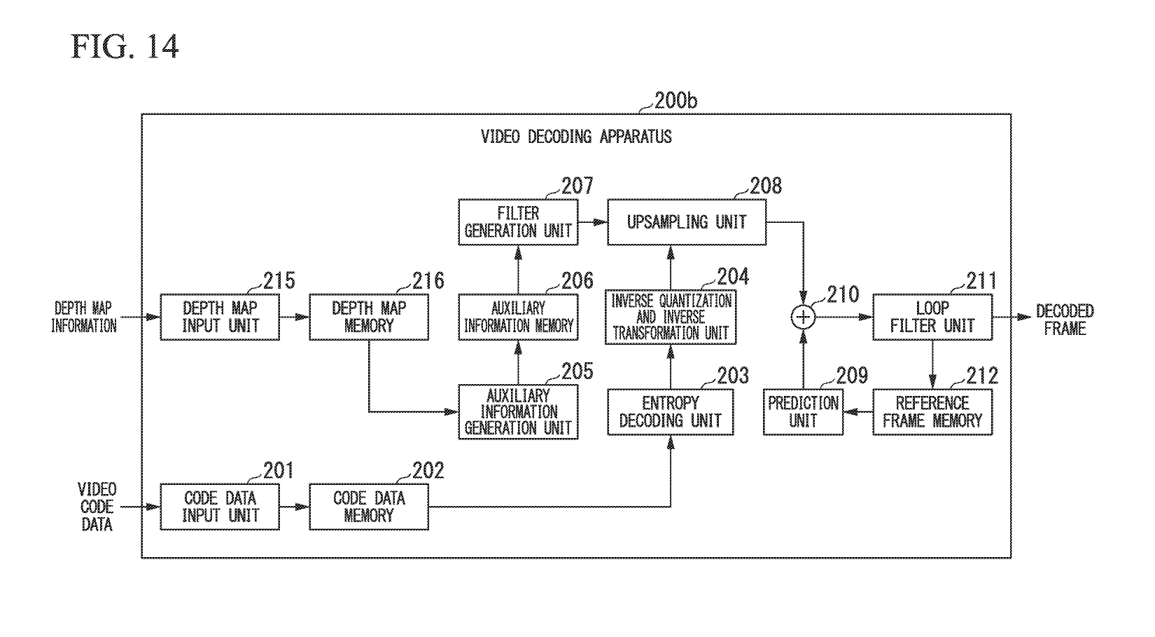

Below, a video decoding apparatus 200b according to the third embodiment will be explained. FIG. 14 is a block diagram that shows the structure of the video decoding apparatus according to the third embodiment. In FIG. 14, parts identical to those in FIG. 6 are given identical reference numerals and explanations thereof are omitted here.

In comparison with the apparatus of FIG. 6, the apparatus of FIG. 14 has distinctive features such that a depth map input unit 215 and a depth map memory 216 are newly provided, and the auxiliary information generation unit 205 generates the auxiliary information utilizing a depth map instead of the low-resolution prediction residual.

The depth map input unit 215 is utilized to input a depth map (information), which is referred to for generating an interpolation filter, into the video decoding apparatus 200b. The depth map memory 216 stores the input depth map.

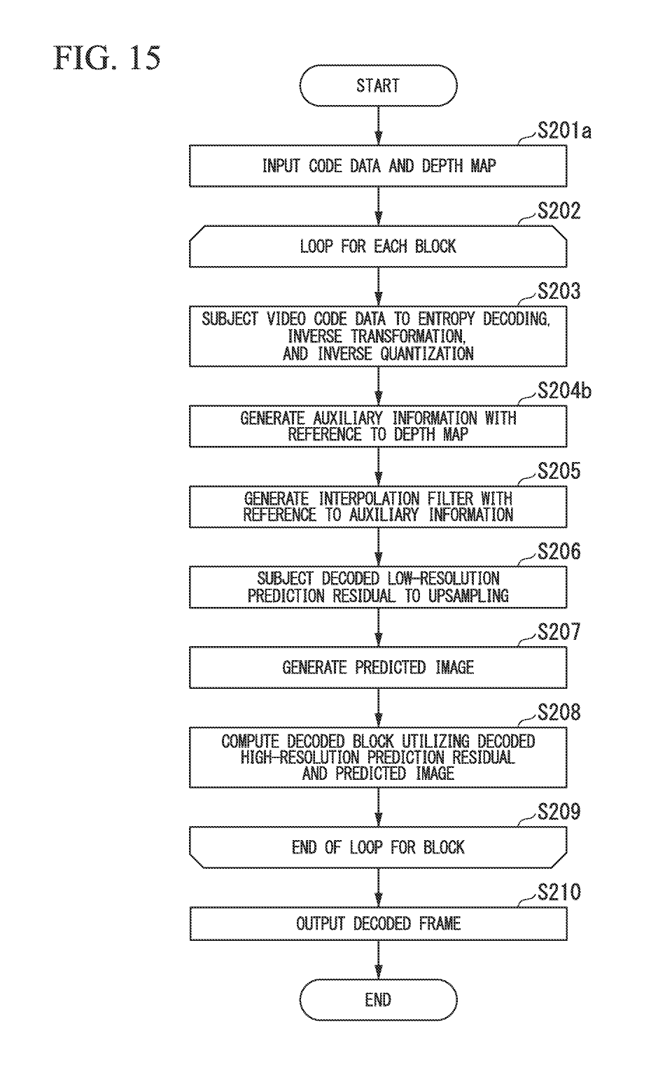

Next, referring to FIG. 15, the operation of the video decoding apparatus 200b of FIG. 14 will be explained. FIG. 15 is a flowchart that shows the operation of the video decoding apparatus 200b of FIG. 14.

In FIG. 15, instead of the auxiliary information generation referring to video information in the first embodiment, a depth map is received from an external device and is utilized to generate the auxiliary information.

In FIG. 15, steps identical to those in FIG. 7 are given identical step numbers and explanations thereof are omitted here.

First, the code data input unit 201 makes video code data input into the video decoding apparatus 200b and stores the data in the code data memory 202. In parallel to this process, the depth map input unit 215 receives a depth map and stores it in the depth map memory 216 (see step S201a).

Here, some frames in the decoding target video have been previously decoded and stored in the reference frame memory 212, and corresponding depth maps are stored in the depth map memory 216.

Next, the decoding target frame is divided into target blocks and each block is subjected to a routine of decoding a relevant signal of the decoding target video frame (see step S202). That is, the following steps S203 to S208 are repeatedly executed until all blocks of the relevant frame have been processed sequentially.

In the operation repeated for each block, first, the entropy decoding unit 203 subjects the code data to entropy decoding, and the inverse quantization and inverse transformation unit 204 subjects the relevant result to the inverse quantization and inverse transformation so as to generate a decoded low-resolution prediction residual (see step S203).

Next, the auxiliary information generation unit 205 generates auxiliary information utilized to generate an interpolation filter with reference to the depth map and prediction information therefor or the like and stores the generated information in the auxiliary information memory (see step S204b).

The following steps S205 to S210 are performed in a manner similar to the corresponding steps in FIG. 7.

Although the above-described third embodiment encodes the video based on the RRU, the depth map may be encoded utilizing RRU. In this case, an interpolation filter for the depth map may be generated with reference to the video information. In another example, RRU is utilized for both the video information and the depth map, the interpolation filter for the depth map is generated utilizing self-reference or input auxiliary information, and the video information is decoded utilizing a decoded depth map. Such a relationship between the video information and the depth map may be reversed.

In addition, the sequence for the encoding and decoding may be arranged to implement bidirectional reference.

Additionally, the depth map may be utilized together with auxiliary information estimated based on the video information (as performed in the first embodiment) or auxiliary information encoded as additional information. For example, for a boundary region obtained based on a depth map, a filter according to the boundary region is generated, and for a non-boundary region, an interpolation filter is generated based on the texture of the relevant video.

Also in the above-described third embodiment, the auxiliary information is generated with reference to a depth map that corresponds to the decoding target frame. However, a depth map that corresponds to a previously-decoded reference frame may be referred to.

In addition, not only the depth map, but also the decoding target frame and prediction information and a reference frame therefor may be referred to, or prediction information for the depth map itself may be referred to.

Also in the third embodiment, the input depth map is directly used. However, if an encoded depth map is utilized, the input depth map may be subjected to a low-pass filter or the like, so as to reduce encoding noises for the depth map.

Additionally, when the interpolation filter is generated by detecting an object boundary, as described in the above-described example, a bit depth by which different objects can be distinguished from each other is sufficient. Therefore, the input depth map may be subjected to bit depth conversion so as to reduce the bit depth of the depth map.

Here, although a simple bit depth conversion may be executed, the number of objects alignment may be determined according to the depth map and information required to distinguish the objects based on the determined number may be obtained as a result of the conversion.

In addition, in the above-described first to third embodiments, RRU is applied to all blocks of the encoding target frame. However, RRU may be applied to part of the blocks. Furthermore, the blocks may have individual downsampling rates.

In such a case, information that indicates whether or not RRU can be applied or the downsampling rate may be encoded and included in additional information. In addition, the corresponding decoding apparatus may have a function of determining whether or not RRU can be applied or the downsampling rate.

For example, in the third embodiment, whether or not RRU can be applied or the downsampling rate may be determined referring to a depth map. In this case, it is preferable to add a prevention or correction function of preventing a decoding disable state due to an encoding noise or transmission error for the depth map.

In the above explanations, the interpolation filter is adaptively generated in all blocks. However, in order to reduce the amount of computation, a predetermined filter may be applied to any block that can obtain sufficient performance utilizing the predetermined filter. In this case, switching referring to video information or auxiliary information may be performed whether a predetermined filter is used or filter generation is performed.

Additionally, the downsampling may utilize a predetermined filter while an adaptively generated auxiliary information may be only applied to the upsampling. A reverse form thereof is also possible.

In the above-described first to third embodiments, the encoding apparatus generates the auxiliary information outside the operation loop. However, the auxiliary information generation may be executed inside the loop (i.e., for each block).

On the other hand, the decoding apparatus generates the auxiliary information inside the operation loop (i.e., for each block). However, the auxiliary information generation may be executed outside the loop if it is possible.

Additionally, although both the encoding apparatus and the decoding apparatus perform the filter generation inside the operation loop, it may be performed outside the loop.

In addition, filters for a plurality of frames may be generated in advance, or any other order of generated filters is possible if the decoding apparatus can generate corresponding filters before decoding the decoding target frame.

In the decoding of the first to third embodiments, the auxiliary information is generated utilizing a decoded low-resolution prediction residual obtained by subjecting the code data to the inverse quantization and inverse transformation or a decoded depth map. However, the auxiliary information may be generated with reference to quantized data before the inverse quantization or transformed data before the inverse transformation.

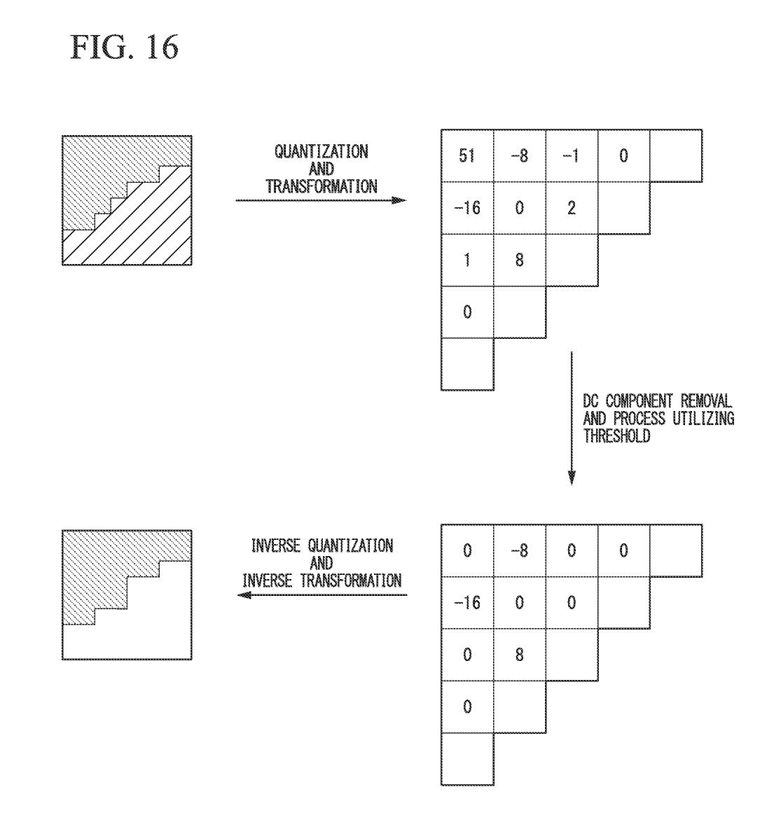

FIG. 16 shows an example in which boundary information is obtained based on DCT coefficients of a depth map which has been transformed and quantized. As shown in FIG. 16, DC (direct current) components are removed from the DCT coefficients obtained by the relevant transformation and quantization, the coefficients (among the AC (alternating current) components) which are less than or equal to a threshold are replaced with 0, and then the coefficients are subjected to the inverse quantization and the inverse transformation. Accordingly, an image which shows considerably accurate boundary information can be restored.

When obtaining auxiliary information required for the interpolation filter generation, the relevant DCT coefficients do not need to be restored as an image, and the auxiliary information can be directly estimated based on a DCT coefficient pattern.

Although the first to third embodiments do not specifically distinguish luminance signals and color difference signals in the encoding target video from each other, they may be distinguished from each other.

For example, only the color difference signal is subjected to the downsampling and upsampling while the luminance signal that maintains an original high resolution is encoded. A reverse handling thereof is also possible.

In another example, different interpolation filters may be applied to the luminance signal and the color difference signal. In this case, the interpolation filter for the luminance signal may be generated with reference to the color difference signal.

In the first to third embodiments, part of the above-described steps may be performed in a different order (from the original order).

The above-described video encoding and decoding operations may be implemented using a computer and a software program, where the program may be provided by storing it in a computer-readable storage medium, or through a network.

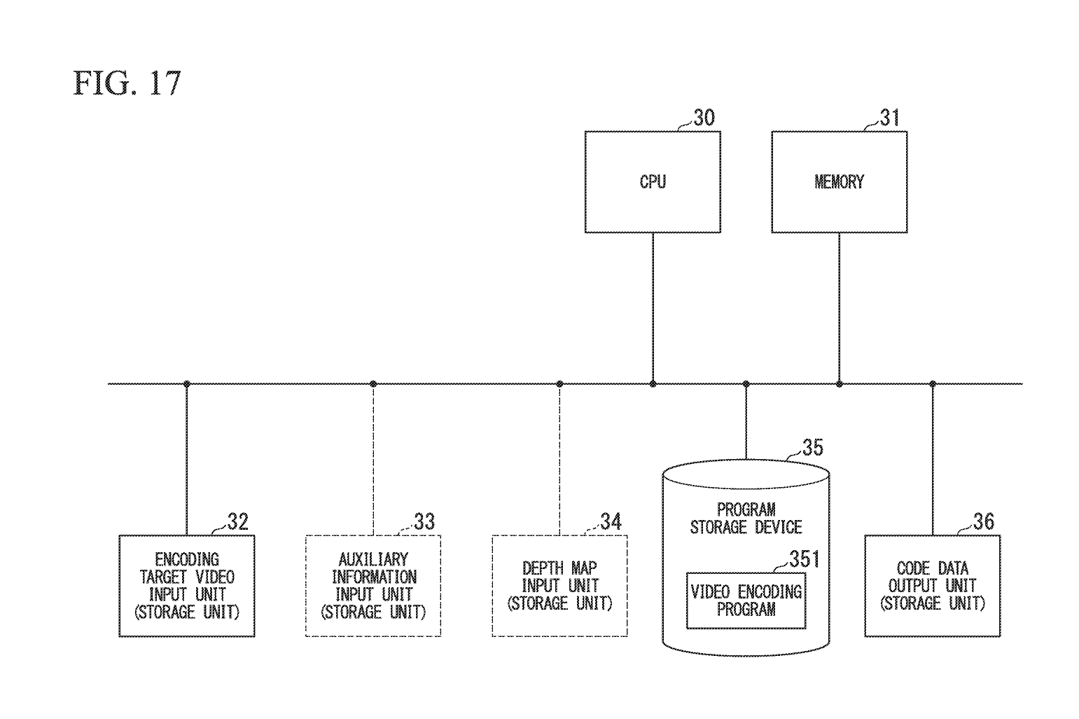

FIG. 17 shows an example of a hardware configuration of the above-described video encoding apparatus formed using a computer and a software program.

In the relevant system, the following elements are connected via a bus:
(i) a CPU 30 that executes the relevant program;
(ii) a memory 31 (e.g., RAM) that stores the program and data accessed by the CPU 30;
(iii) an encoding target video input unit 32 that makes a video signal of an encoding target from a camera or the like input into the video encoding apparatus and may be a storage unit (e.g., disk device) which stores the video signal;
(iv) a program storage device 35 that stores a video encoding program 351 which is a software program for making the CPU 30 execute the operation explained referring to the drawings such as FIGS. 2, 9, and 13; and
(v) a code data output unit 36 that outputs coded data via a network or the like, where the coded data is generated by executing the video encoding program that is loaded on the memory 31 and executed by the CPU 30, and the output unit may be a storage unit (e.g., disk device) which stores the coded data.

In addition, if it is necessary to implement the encoding explained in the second or third embodiment, the following units may be further connected:
(vi) an auxiliary information input unit (storage unit) 33 that receives auxiliary information via a network or the like and may be a storage unit (e.g., disk device) which stores an auxiliary information signal; and
(vii) a depth map input unit (storage unit) 34 that receives a depth map for the video as the encoding target via a network or the like and may be a storage unit (e.g., disk device) which stores a depth map signal.

Other hardware elements (not shown) are also provided so as to implement the relevant method, which are a code data storage unit, a reference frame storage unit, and the like. In addition, a video signal code data storage unit or a prediction information code data storage unit may be used.

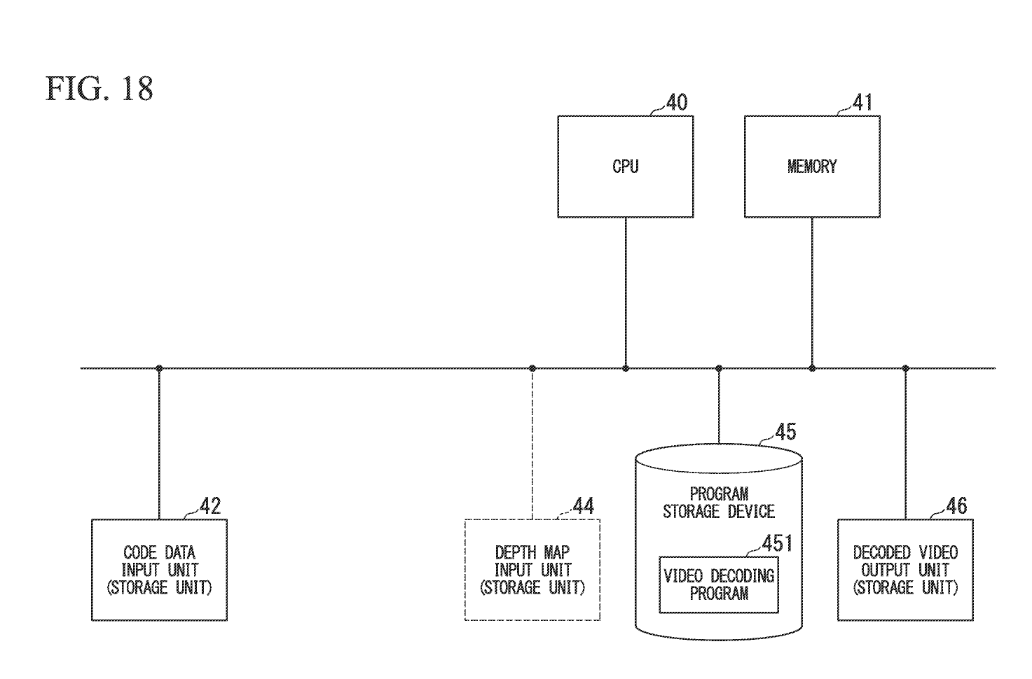

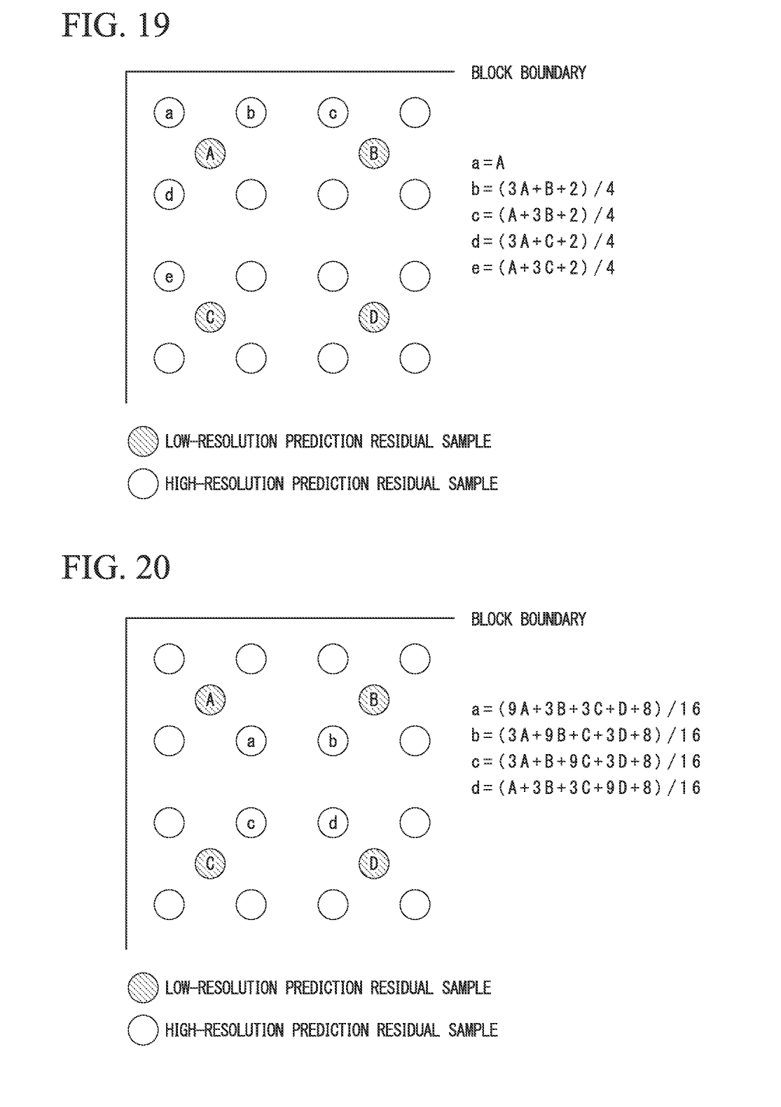

FIG. 18 shows an example of a hardware configuration of the above-described video decoding apparatus formed using a computer and a software program.

In the relevant system, the following elements are connected via a bus:
(i) a CPU 40 that executes the relevant program;
(ii) a memory 41 (e.g., RAM) that stores the program and data accessed by the CPU 40;
(iii) a code data input unit 42 that makes code data obtained by a video encoding apparatus (which performs a method according to the present invention) input into the video decoding apparatus, where the input unit may be a storage unit (e.g., disk device) which stores the code data;
(iv) a program storage device 45 that stores a video decoding program 451 which is a software program for making the CPU 40 execute the operation explained referring to the drawings such as FIGS. 7, 11, and 15; and
(v) a decoded video data output unit 46 that outputs decoded video to a reproduction device or the like, where the decoded video is obtained by executing the video decoding program that is loaded on the memory 41 and executed by the CPU 40.

In addition, if it is necessary to implement the decoding explained in the second or third embodiment, the following unit may be further connected: a depth map input unit (storage unit) 44 that receives a depth map which corresponds to video information as the decoding target via a network or the like and may be a storage unit (e.g., disk device) which stores a depth map signal.

Other hardware elements (not shown) are also provided so as to implement the relevant method, which include a reference frame storage unit. In addition, a video signal code data storage unit or a prediction information code data storage unit may be used.

As described above, any additional information encoded together with the video signal or information that can be predicted from video information is utilized to adaptively generate or select an interpolation filter for each block to be processed pertaining to the prediction residual in the decoding. Therefore, it is possible to improve the upsampling accuracy of the prediction residual for RRU and reconstruct the final image having the original high resolution and desirable quality.

Accordingly, in video encoding that employs additional information such as a depth map (as a representative), the encoding efficiency can be improved utilizing RRU while sufficiently securing required subjective quality.

Although the above-described RRU mode is preferably applied to the free viewpoint video encoding, the present invention is not limited thereto. However, the free viewpoint video encoding or the like is originally an encoding method utilizing additional information such as a depth map. Therefore, when the present invention is applied to such an encoding method, it is unnecessary to include extra additional information in the relevant signal.

A program for executing the functions of the units shown in FIG. 1, 6, 8, 10, 12, or 14 may be stored in a computer readable storage medium, and the program stored in the storage medium may be loaded and executed on a computer system, so as to perform the relevant video encoding or decoding operation.

Here, the computer system has hardware resources which may include an OS and peripheral devices. The computer system also has a WWW system that provides a homepage service (or viewable) environment.

The above computer readable storage medium is a storage device, for example, a portable medium such as a flexible disk, a magneto optical disk, a ROM, or a CD-ROM, or a memory device such as a hard disk built in a computer system.

The computer readable storage medium also includes a device for temporarily storing the program, such as a volatile memory (RAM) in a computer system which functions as a server or client and receives the program via a network (e.g., the Internet) or a communication line (e.g., a telephone line).

The above program, stored in a memory device or the like of a computer system, may be transmitted via a transmission medium or by using transmitted waves passing through a transmission medium to another computer system. The transmission medium for transmitting the program has a function of transmitting data, and is, for example, a (communication) network such as the Internet or a communication line such (e.g., a telephone line).

In addition, the program may execute part of the above-explained functions.

The program may also be a “differential” program so that the above-described functions can be executed by a combination program of the differential program and an existing program which has already been stored in the relevant computer system.

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a purpose that essentially requires improvement in the upsampling accuracy of the prediction residual in RRU and also in the quality of the finally obtained image.

1. A video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:
a filter determination step that determines the interpolation filter whose filter coefficients are not encoded, by adaptively generating or selecting, for each processing region, the interpolation filter with reference to information that indicates a texture characteristic of the processing region;
a downsampling step that obtains a low-resolution prediction residual by subjecting the prediction residual signal to downsampling that utilizes the interpolation filter.

2. (canceled)

3. (canceled)

4. (canceled)

5. (canceled)

6. A video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:
a filter determination step that determines the interpolation filter whose filter coefficients are not encoded, by adaptively generating or selecting, for each processing region, the interpolation filter with reference to motion vectors for motion-compensated prediction of the processing region and its peripheral regions;
a downsampling step that obtains a low-resolution prediction residual by subjecting the prediction residual signal to downsampling that utilizes the interpolation filter, wherein:
a status of a boundary in the processing region and its peripheral regions is estimated based on the motion vectors and the interpolation filter is generated or selected according to a result of the estimation.

7. (canceled)

8. A video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:
a filter determination step that determines the interpolation filter whose filter coefficients are not encoded, by adaptively generating or selecting, for each processing region, the interpolation filter with reference to auxiliary information that correlates with the video;
a downsampling step that obtains a low-resolution prediction residual by subjecting the prediction residual signal to downsampling that utilizes the interpolation filter, wherein:
when the video is a video from a viewpoint among a multi-viewpoint video obtained by capturing a scene from a plurality of viewpoints, the auxiliary information is information of a video from another viewpoint.

9. The video encoding method in accordance with claim 8, further comprising:
an auxiliary information encoding step that encodes the auxiliary information to generate auxiliary information code data; and
a multiplexing step that outputs code data in which the auxiliary information code data is multiplexed with video code data.

10. (canceled)

11. A video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:
a filter determination step that determines the interpolation filter whose filter coefficients are not encoded, by adaptively generating or selecting, for each processing region, the interpolation filter with reference to auxiliary information that correlates with the video;
a downsampling step that obtains a low-resolution prediction residual by subjecting the prediction residual signal to downsampling that utilizes the interpolation filter, wherein:
the auxiliary information is a depth map that corresponds to the video.

12. The video encoding method in accordance with claim 11, further comprising:
an auxiliary information generation step that generates information that indicates a status of a boundary in the processing region, as the auxiliary information, based on the depth map.

13. The video encoding method in accordance with claim 11, wherein:
the filter determination step generates or selects the interpolation filter with reference to a video from another viewpoint in addition to the depth map.

14. The video encoding method in accordance with claim 11, further comprising:
a depth map encoding step that encodes the depth map to generate depth map code data; and
a multiplexing step that outputs code data in which the depth map code data is multiplexed with video code data.

15. A video encoding method utilized when dividing each frame that forms an encoding target video into a plurality of processing regions and subjecting each processing region to predictive encoding which is executed by subjecting a prediction residual signal to downsampling that utilizes an interpolation filter, the method comprising:
a filter determination step that determines the interpolation filter whose filter coefficients are not encoded, by adaptively generating or selecting, for each processing region, the interpolation filter with reference to auxiliary information that correlates with the video;
a downsampling step that obtains a low-resolution prediction residual by subjecting the prediction residual signal to downsampling that utilizes the interpolation filter, wherein:
information of the encoding target video is a depth map, and the auxiliary information is information of the video at the same viewpoint, said information corresponding to the depth map.

16. The video encoding method in accordance with claim 15, further comprising:
an auxiliary information generation step that generates information that indicates a status of a boundary in the processing region, as the auxiliary information, based on the information of the video at the same viewpoint.

17. A video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:
a filter determination step that determines the interpolation filter whose filter coefficients are not decoded, by adaptively generating or selecting, for each processing region, the interpolation filter with reference to information that indicates a texture characteristic of the processing region; and
an upsampling step that obtains a high-resolution prediction residual by subjecting the prediction residual signal to upsampling that utilizes the interpolation filter.

18. (canceled)

19. (canceled)

20. (canceled)

21. (canceled)

22. A video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:
a filter determination step that determines the interpolation filter whose filter coefficients are not decoded, by adaptively generating or selecting, for each processing region, the interpolation filter with reference to motion vectors for motion-compensated prediction of the processing region and its peripheral regions; and
an upsampling step that obtains a high-resolution prediction residual by subjecting the prediction residual signal to upsampling that utilizes the interpolation filter, wherein:
a status of a boundary in the processing region and its peripheral regions is estimated based on the motion vectors and the interpolation filter is generated or selected according to a result of the estimation.

23. (canceled)

24. (canceled)

25. A video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:
a filter determination step that determines the interpolation filter whose filter coefficients are not decoded, by adaptively generating or selecting, for each processing region, the interpolation filter with reference to auxiliary information that correlates with the video; and
an upsampling step that obtains a high-resolution prediction residual by subjecting the prediction residual signal to upsampling that utilizes the interpolation filter, wherein:
when the video is a video from a viewpoint among a multi-viewpoint video obtained by capturing a scene from a plurality of viewpoints, the auxiliary information is a video from another viewpoint.

26. The video decoding method in accordance with claim 25, further comprising:
a demultiplexing step that demultiplexes the code data into auxiliary information code data and video code data; and
an auxiliary information decoding step that decodes the auxiliary information code data to generate auxiliary information,
wherein the filter determination step generates or selects the interpolation filter with reference to the decoded auxiliary information.

27. A video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:
a filter determination step that determines the interpolation filter whose filter coefficients are not decoded, by adaptively generating or selecting, for each processing region, the interpolation filter with reference to auxiliary information that correlates with the video, and
an upsampling step that obtains a high-resolution prediction residual by subjecting the prediction residual signal to upsampling that utilizes the interpolation filter, wherein:
the auxiliary information is a depth map that corresponds to information of the video.

28. The video decoding method in accordance with claim 27, further comprising:
an auxiliary information generation step that generates information that indicates a status of a boundary in the processing region, as the auxiliary information, based on the depth map.

29. The video decoding method in accordance with claim 27, wherein:
the filter determination step generates or selects the interpolation filter with reference to a video from another viewpoint in addition to the depth map.

30. The video decoding method in accordance with claim 27, further comprising:
a demultiplexing step that demultiplexes the code data into depth map code data and video code data; and
a depth map decoding step that decodes the depth map code data to generate a depth map.

31. A video decoding method utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the method comprises:
a filter determination step that determines the interpolation filter whose filter coefficients are not decoded, by adaptively generating or selecting, for each processing region, the interpolation filter with reference to auxiliary information that correlates with the video, and
an upsampling step that obtains a high-resolution prediction residual by subjecting the prediction residual signal to upsampling that utilizes the interpolation filter, wherein:
information of the encoding target video is a depth map, and the auxiliary information is information of the video at the same viewpoint, said information corresponding to the depth map.

32. The video decoding method in accordance with claim 31, further comprising:
an auxiliary information generation step that generates information that indicates a status of a boundary in the processing region, as the auxiliary information, based on the information of the video at the same viewpoint.

33. A video encoding apparatus utilized when dividing each frame that forms an encoding target video into a plurality of processing regions and subjecting each processing region to predictive encoding which is executed by subjecting a prediction residual signal to downsampling that utilizes an interpolation filter, the apparatus comprising:
a filter determination device that determines the interpolation filter whose filter coefficients are not encoded, by adaptively generating or selecting, for each processing region, the interpolation filter with reference to auxiliary information that correlates with the video;
a downsampling device that obtains a low-resolution prediction residual by subjecting the prediction residual signal to downsampling that utilizes the interpolation filter, wherein:
when the video is a video from a viewpoint among a multi-viewpoint video obtained by capturing a scene from a plurality of viewpoints, the auxiliary information is information of a video from another viewpoint.

34. A video decoding apparatus utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the apparatus comprises:
a filter determination device that determines the interpolation filter whose filter coefficients are not decoded, by adaptively generating or selecting, for each processing region, the interpolation filter with reference to auxiliary information that correlates with the video; and
an upsampling device that obtains a high-resolution prediction residual by subjecting the prediction residual signal to upsampling that utilizes the interpolation filter, wherein:
when the video is a video from a viewpoint among a multi-viewpoint video obtained by capturing a scene from a plurality of viewpoints, the auxiliary information is information of a video from another viewpoint.

35. A video encoding program by which a computer executes the steps in the video encoding method in accordance with any one of claims 1, 6, 8, 11, and 15.

36. A video decoding program by which a computer executes the steps in the video decoding method in accordance with any one of claims 17, 22, 25, 27, and 31.

37. (canceled)

38. (canceled)

39. A video encoding apparatus utilized when dividing each frame that forms an encoding target video into a plurality of processing regions and subjecting each processing region to predictive encoding which is executed by subjecting a prediction residual signal to downsampling that utilizes an interpolation filter, the apparatus comprising:
a filter determination device that determines the interpolation filter whose filter coefficients are not encoded, by adaptively generating or selecting, for each processing region, the interpolation filter with reference to auxiliary information that correlates with the video;
a downsampling device that obtains a low-resolution prediction residual by subjecting the prediction residual signal to downsampling that utilizes the interpolation filter, wherein:
the auxiliary information is a depth map that corresponds to the video.

40. A video encoding apparatus utilized when dividing each frame that forms an encoding target video into a plurality of processing regions and subjecting each processing region to predictive encoding which is executed by subjecting a prediction residual signal to downsampling that utilizes an interpolation filter, the apparatus comprising:
a filter determination device that determines the interpolation filter whose filter coefficients are not encoded, by adaptively generating or selecting, for each processing region, the interpolation filter with reference to auxiliary information that correlates with the video;
a downsampling device that obtains a low-resolution prediction residual by subjecting the prediction residual signal to downsampling that utilizes the interpolation filter, wherein:
information of the encoding target video is a depth map, and the auxiliary information is information of the video at the same viewpoint, said information corresponding to the depth map.

41. A video decoding apparatus utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the apparatus comprises:
a filter determination device that determines the interpolation filter whose filter coefficients are not decoded, by adaptively generating or selecting, for each processing region, the interpolation filter with reference to auxiliary information that correlates with the video; and
an upsampling device that obtains a high-resolution prediction residual by subjecting the prediction residual signal to upsampling that utilizes the interpolation filter, wherein:
the auxiliary information is a depth map that corresponds to information of the video.

42. A video decoding apparatus utilized when decoding code data of an encoding target video, wherein each frame that forms the video is divided into a plurality of processing regions, each processing region is subjected to predictive decoding which is executed by subjecting a prediction residual signal to upsampling that utilizes an interpolation filter, and the apparatus comprises:
a filter determination device that determines the interpolation filter whose filter coefficients are not decoded, by adaptively generating or selecting, for each processing region, the interpolation filter with reference to auxiliary information that correlates with the video; and
an upsampling device that obtains a high-resolution prediction residual by subjecting the prediction residual signal to upsampling that utilizes the interpolation filter, wherein:
information of the encoding target video is a depth map, and the auxiliary information is information of the video at the same viewpoint, said information corresponding to the depth map.
